(19) United States
(12) Patent Application Publication
(10) Pub. No.: US 2008/0107772 A1
(43) Pub. Date: May 8, 2008

(54) Lactic Acid Bacteria for the Treatment of Food

(75) Inventors: Michael E. Stiles, Edmonton (CA); Lynn McMullen, Edmonton (CA); David C. Smith, Toronto (CA)

Correspondence Address: WILLIAM J BUNDREN;THE LAW OFFICE OF WILLIAM J BUNDREN, 734 LaRue Road, Millersville, MD, 21108, US

(73) Assignee: CANBIOCIN INC.

(21) Appl. No.: 11/931,061

(22) Filed: Oct. 31, 2007

Related U.S. Application Data
(63) Continuation of application No. 11/013,929, filed on Dec. 17, 2004.
Application No. 11/013,929 is a continuation-in-part of application No. 10/870,032, filed on Jun. 18, 2004.
Application No. 11/013,929 is a continuation-in-part of application No. PCT/CA2004/000909, filed on Jun. 18, 2004.
Application No. 11/013,929 is a continuation-in-part of application No. PCT/CA2003/000986, filed on Jun. 27, 2003.

(30) Foreign Application Priority Data
Jun. 20, 2003 (CA) 2432907

(51) Int. Cl. A23L 3/3463; A23L 1/48

(52) U.S. Cl. 426/9; 426/335; 426/61

(57) ABSTRACT

The compositions and methods of the present invention involve the use of bacteria and/or their fermentate products to treat foods, such as fresh and processed meat products.

The present invention is a continuation of 11/103,929 filed Dec. 17, 2004; which is a continuation-in-part of U.S. Ser. No. 10/870,032, filed Jun. 18, 2004; and International application No. PCT/CA2004/000909, filed Jun. 18, 2004, which is a continuing application of Canadian Patent Application No. 2,432,907, filed Jun. 20, 2003; and a continuation-in-part of International application No. PCT/CA03/00986, filed Jun. 27, 2003.

### I . FIELD OF THE INVENTION

This invention relates to novel strains of Carnobacterium maltaromaticum that produce bacteriocin molecules having antimicrobial activity. The bacteria of the present invention, and the bacteriocin(s) produced by the bacteria or other bacteria, may be used to treat food and as a food preservative. In a particular application of the invention, the bacteriocin and the bacterial strain that produces the bacteriocin are used to control pathogenic bacteria, including but not limited to, Listeria monocytogenes (“L. monocytogenes”) in meat products, without jeopardizing the storage life of the meats.

### II. BACKGROUND OF THE INVENTION

Carnobacterium maltaromaticum is one species of a diverse group of bacteria that are classified as Lactic Acid Bacteria (LAB). LAB have been utilized for centuries in the food and dairy industries in the production of fermented foods. Important in this capacity is their ability to produce aromatic and flavor-enhancing compounds (Stiles and Holzapfel, 1997; Garr et al.; 2002). LAB have been characterized by their ability to produce a variety of isomers of lactic acid from the fermentation of carbohydrates. Atypical Carnobacteria are distinct due their inability to grow on acetate agar at pH 5.6, while being able to produce virtually pure L(+)-lactic acid from glucose and, their ability to ferment both glycerol and mannitol, properties that are unusual in lactobacilli (Holzapfel and Gerber, 1983; Shaw and Harding, 1984).

One of the methods that C. maltaromaticum may inhibit potentially pathogenic bacteria is through the production of bacteriocins. Bacteriocins are ribosomally synthesized, low molecular weight antibacterial proteinaceous materials that are able to kill closely related bacteria (Klaenhammer; 1993). Bacteriocins have been isolated from beef, spoiled ham, as well as from French mold-ripened soft cheese (Jack et al., 1996; Herbin et al., 1997). Because bacteriocins are isolated from foods such as meat and dairy products, which normally contain LAB, both LAB and bacteriocins have been consumed for centuries. Bacteriocins produced from C. maltaromaticum have been shown to be susceptible to proteolytic enzymes. The bacteriocin from C. maltaromaticum LV17 is stable during heat treatment at 62° C., boiling for 30 min and, after autoclaving at 121° C. for 15 minutes. Trypsin, protease types I, IV, VIII, XIV, α-chymotrypsin; β-chymotrypsin and papain inactivated the bacteriocin, while non-proteolytic enzymes did not (Ahn and Stiles, 1990b). Piscicolin 126; a bacteriocin produced by C. maltaromaticum JG126 was inactivated by α- and β-chymotrypsin; proteases (types I, XIV, XXIII and trypsin), but catalase, lipase or lysozyme had no effect (Jack et al., 1996). Similarly, the bacteriocin produced by C. maltaromaticum LV61 is resistant to heat (100° C. for 20 minutes), while being inactivated by α-chymotrypsin, trypsin, pepsin, papain and proteinase K. Treatment with catalase, α-amylase, lipase, phosphlipase C, DNase I and lysozyme did not affect the antibacterial activity (Schillinger et al., 1993). This evidence has indicated that ingestion of bacteriocins would not have an effect on the beneficial gut microorganisms. Trypsin has been shown to inactivate the bacteriocin, nisin (Hara et al., 1962).

There is a continual need for new food preservatives bearing new and useful properties. Further, there is growing interest in replacing traditional “chemical” food preservatives with effective “natural” preservatives, especially those that inhibit pathogenic microorganisms. In this regard, considerable research has been conducted on bacterial proteins, known as bacteriocins, which are often heat stable and have antimicrobial activity.

Recent years have seen major advances in the development of microbial metabolites with antagonistic activities towards spoilage and pathogenic microorganisms associated with food. There now exists many bacteriocins, but only a few have been fully characterized and evaluated for food use. Additionally, consumer emphasis is now on minimally processed foods that are natural and preservative free. Because of this, there is considerable resistance to the use of chemical additives as food preservatives. Other biological inhibitors produced by microorganisms are currently being investigated for use in foods. Of particular interest are those antibacterial substances such as bacteriocins that are produced by Lactic Acid Bacteria (“LAB”) .

Bacteriocins, which are anti-bacterial peptides and proteins produced by LAB as normal by-products of their metabolism, are potentially very attractive natural preservatives. Many LAB are well-established, industrially important bacteria that include the genera Lactococcus, Streptococcus, Pediococcus, Leuconostoc, Lactobacillus and Carnobacterium. They have been used for the production of fermented foods that have been consumed safety for thousands of years. Because they have achieved a status as “safe” microorganisms, they are a particularly suitable source of natural antimicrobials, such as bacteriocins, and for use in foods.

Bacteriocins can have a broad or narrow spectrum of antibacterial activity, and are not lethal to the cells that produce them. Bacteria protect themselves from the lethal effects of their own bacteriocins by the production of immunity proteins.

C. maltaromaticum is a Gram-positive, non-motile, non-sporeforming, rod-shaped bacterium, recently redefined from the genus Lactobacillus to Carnobacterium. C. maltaromaticum has been indicated as one of a large, diverse group of lactic acid-producing bacteria, which metabolize glucose to produce tactic acid and other acids that inhibit the growth of several pathogenic bacteria. C. maltaromaticum was initially found in salmonid fish, but has since been found on various food products, from meats and fish to fruits and vegetables, produced and stored by current agricultural practices, at levels exceeding 1×10⁷ cfu/g. Lactic acid bacteria have been used for centuries in the fermentation and preservation of food products (e.g., yogurts, sausages, vegetables, breads, wine, cheeses and milk). C. maltaromaticum has already been used as part of a starter bacterial culture in sausage fermentation in France.

Notwithstanding the usefulness of the above described natural preservatives, a need still exists for lactic acid bacteria and their bacteriocins that are capable of controlling pathogenic and spoilage bacteria in specific food products.

### III. SUMMARY OF THE INVENTION

This invention relates to novel strains of bacteriocin-producing Carnobacterium maltaromaticum (“C. maltaromaticum”), previously known as Carnobacterium piscicola (“C. piscicola”), having exceptional antimicrobial activities. The novel strains of the present invention, CB1, CB2, and CB3 produce multiple bacteriocins, including carnobacteriocin BM1 and piscicolin 126. These bacteriocins have broad spectrum anti-Listerial activity, and the producer strains grow at refrigeration temperatures and do not cause food spoilage relative to other similarly related spoilage microorganisms or within the typical shelf-life of the food.

An embodiment of the invention includes Carnobacterium maltaromaticum strains CB1 , CB2, CB3, LV17, UAL26, ATCC 35586 and ATCC 43225 for use as a preservative in ready-to-eat (RTE) and fresh comminuted, processed meat products, preferably at a maximum inoculation concentration of 1×10⁴ colony forming units (cfu)/g.

An embodiment of the present invention includes a method of treating fresh food by applying C. maltaromaticum, its pasteurized or unpasteurized fermentate, or combinations thereof to the food. In these embodiments of the invention, the bacteria and its pasteurized or unpasteurized fermentate produce a predictable or controlled storage life.

In preferred embodiments of the invention, the food is treated with the combination of natural bacteria and its pasteurized or unpasteurized fermentate, or one or more bacteriocin fermentates produced by a different bacterium. In the most preferred embodiment of the invention, the food is treated with the combination of selected natural bacteria and a pasteurized or unpasteurized fermentate of a selected natural bacterial culture.

An embodiment of the present invention includes using a composition of the present invention to further protect a food product from the growth of gram positive pathogenic bacteria including, but not limited to, Listeria monocytogenes. The compositions of the present invention are effective against strains of L. monocytogenes serotypes ½a, ½b: 3a and 4b.

The method of the present invention includes the use of one or more natural bacterial cultures, homologous pasteurized or unpasteurized fermentate, heterologous pasteurized or unpasteurized fermentate, or combinations thereof. The natural bacterial cultures of the present invention are described above. A homologous fermentate refers to the culture supernatant of a single bacterial culture, typically prepared according to standard preparation techniques. A heterologous fermentate refers to the culture supernatant derived from a different bacterial culture typically prepared according to standard preparation techniques. The homologous or heterologous fermentate may be i) pasteurized or unpasteurized, ii) lyophilized, or iii) otherwise dried. Two or more bacterial cultures may be mixed or added separately. Two or more fermentates may be mixed or added separately. A bacterial culture combined with one or more fermentates may be mixed or added sequentially.

In another exemplary embodiment, the present invention comprises a culture of bacterial strain CB1. CB1 was deposited in the American Type Culture Collection (10801 University Boulevard, Manassas, Va. USA 20118) on 9 Jul. 2003, and received Accession No. PTA-5313.

In another exemplary embodiment, the present invention comprises a culture of bacterial strain CB2. CB2 was deposited in the American Type Culture Collection (10801 University Boulevard, Manassas, Va. USA 20118) on 9 Jul. 2003, and received Accession No, PTA-5314.

In another exemplary embodiment, the present invention comprises a culture of bacterial strain CB3. CB3 was deposited in the American Type Culture Collection (10801 University Boulevard, Manassas, Va. USA 20118) on 9 Jul. 2003, and received Accession No. PTA-5315.

In another exemplary embodiment, the present invention comprises the use CB1, CB2, and/or CB3, or combinations thereof, for the treatment of food, for the treatment of spoilage bacteria on food, for the treatment of pathogenic bacteria on food, and/or establishes a predictable storage life for a food or food product. Strains CB1, CB2, and/or CB3 may be used alone or in combination; may be used with or without their respective bacteriocins; may be used with or without a fermentate comprising their respective bacteriocins; may be used in combination with one or more bacteriocin-producing bacteria, including but not limited to a lactic acid bacterium; and/or may be used with one or more bacteriocins produced from a different bacterium; and/or may be used with or without a fermentate comprising one or more bacteriocins produced from a different bacteriocin.

In another exemplary embodiment, the present invention comprises a method of preserving foods or beverages, the method comprising adding to the food or beverage an effective amount of a bacterial culture of the present invention, alone or in combination with a fermentate. The inventors have found that an amount of 10², or less, colony forming units (“cfu”) per gram or per cm² is typically not sufficient to compete with the existing adventitious microbial population. The inventor has found that 10-fold greater than the initial background microflora, typically about 10³ cfu per gram or per cm² or greater, is sufficient to overcome the growth of the existing adventitious bacterial (e.g., background microflora) population. One skilled in the art will recognize that the amount of adventitious bacteria in a food product is variable. In accordance with the present invention, the amount of the composition should be about ten times or more higher than the amount of adventitious spoilage bacteria.

In preferred embodiments of the invention, the method includes treating fresh meat. In the most preferred embodiments of the invention, the method includes treating or preserving fresh sausage or vacuum-packaged wieners.

The present invention also relates to the use of the bacterial composition and/or bacteriocin produced by the composition in the treatment of Listeria spp, to inhibit the growth of Listeria spp. in meats.

The invention also relates to a fermentate comprising one or more bacteriocins produced by strains CB1, CB2, and/or CB3. In preferred embodiments of the invention, the fermentate comprises piscicolin 126, carnobacteriocin BM1, and an identifiable but yet uncharacterized proteinaceous compound(s) having antibacterial activity.

In the embodiments of the invention that include a bacteriocin, the bacteriocin may be isolated from natural sources, may be produced by one or more strains of the present invention, may be produced by another bacterial strain, or may be produced by genetic modification e.g., the use of a recombinant expression vector).

An advantage of the invention is unprecedented anti-listerial activity. Such a broad anti-listerial spectrum is exceptional. Another advantage of the invention is that there is both bactericidal and bacteriostatic potential. Yet another advantage of the invention is that these bacteria grow at temperatures as low as 0° C., which indicates that they grow and are effective under refrigeration temperatures that are essential for the preservation of meats. Yet a further advantage of the invention is that these strains do not cause significant spoilage of the meats in and of themselves.

The accompanying drawings show illustrative embodiments of the invention from which these and other of the objectives, novel features and advantages will be readily apparent.

### IV. BRIEF DESCRIPTION OF THE DRAWINGS

FIG. 1 is a graph of the anti-listerial activity of a composition of the present invention illustrating the reduction of bacterial numbers and the inhibition of a cocktail of four strains of L. monocytogenes in the presence of 10³ and 10⁴ cfu of C. maltaromaticum CB1 inoculated per gram of pork sausage samples stored at 5° C. for greater than the proposed 15-day refrigerated storage life of the sausages.

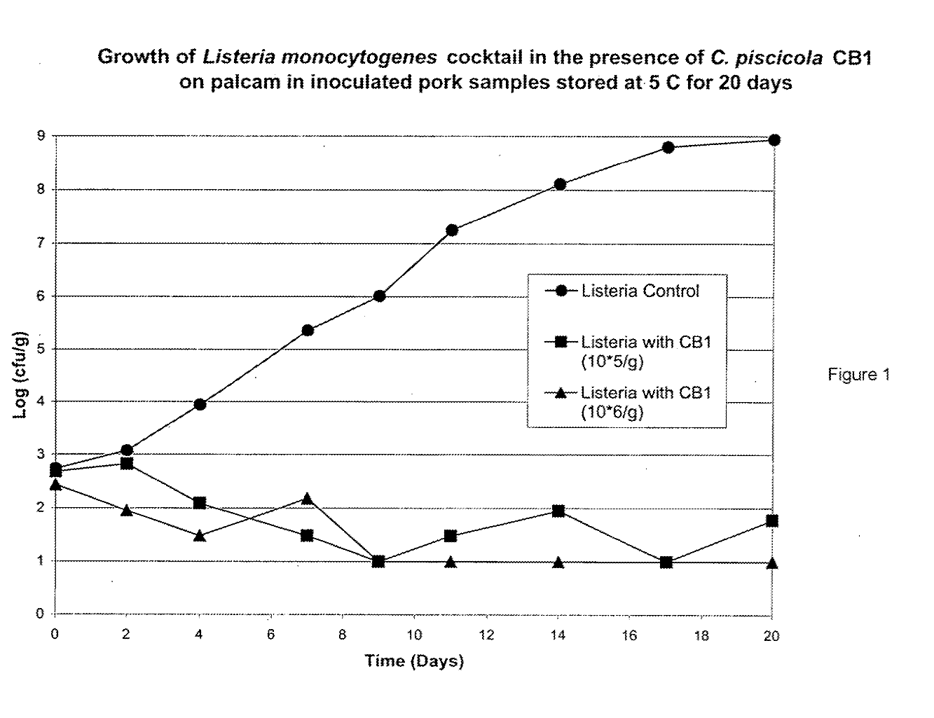

FIG. 2 is a graph of the first of three replicate trials illustrating the reduction of bacterial numbers and the inhibition of a cocktail of four strains of L. monocytogenes inoculated at 10² to 10³ cfu per cm² in the presence of 10⁴ cfu of C. maltaromaticum CB1 or CB3 per cm² on the surface of vacuum-packaged wieners stored at 5° C. over the 12-week refrigerated storage life of the product.

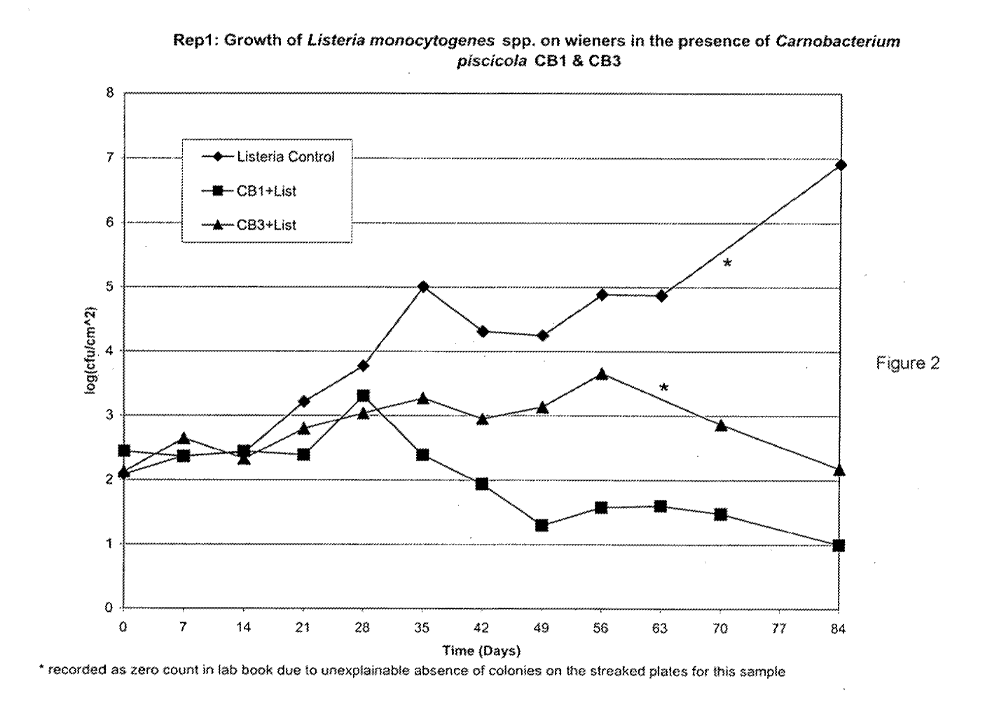

FIG. 3 is a graph of the second of three replicate trials illustrating the reduction of bacterial numbers and the inhibition of a cocktail of four strains of L. monocytogenes inoculated at 10² to 10³ cfu per cm² in the presence of 10⁴ cfu of C. maltaromaticum CB1 or CB3 per cm² on the surface of vacuum-packaged wieners stored at 5° C. over the 12-week refrigerated storage life of the product.

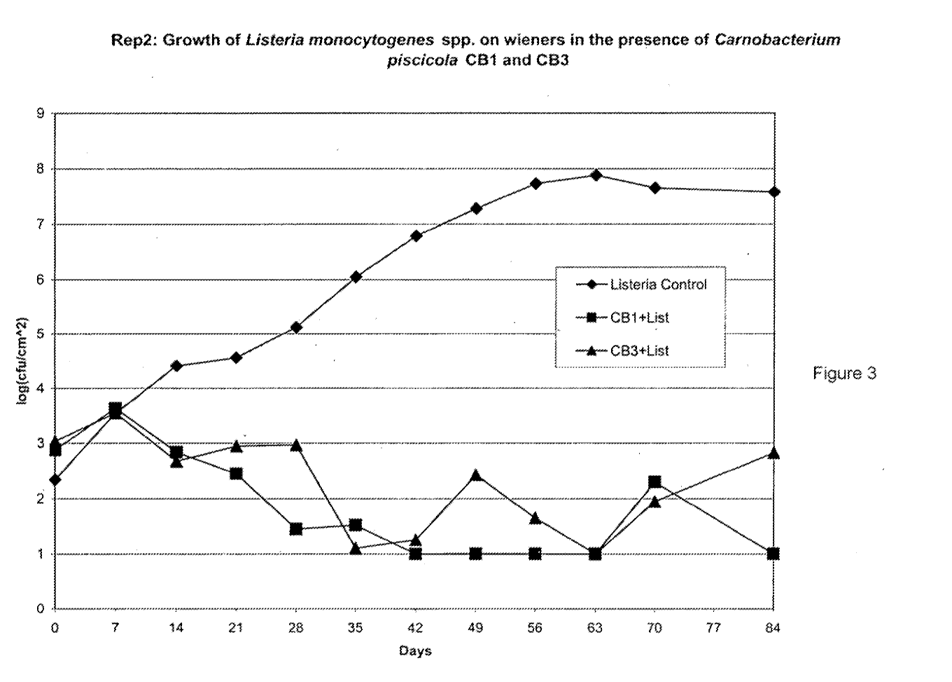

FIG. 4 is a graph of the third of three replicate trials illustrating the reduction of bacterial numbers and the inhibition of a cocktail of four strains of L. monocytogenes inoculated at 10² to 10³ cfu per cm² in the presence of 10⁴ cfu of C. maltaromaticum CB1 or CB3 per cm² on the surface of vacuum-packaged wieners stored at 5° C. over the 12-week refrigerated storage life of the product.

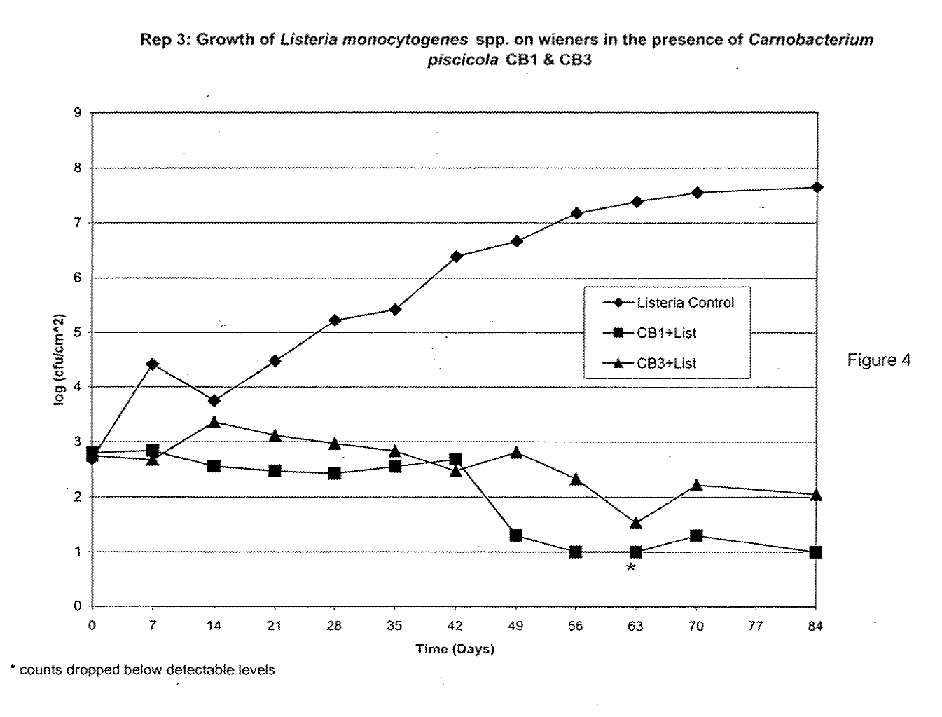

### V. SPECIFIC DESCRIPTION OF THE INVENTION

A composition of the present invention includes strains of Carnobacterium maltaromaticum, and each producing at least one, and typically three, bacteriocins. C. maltaromaticum CB1 produces bacteriocins piscicolin 126, carnobacteriocin BM1, and another uncharacterized bacteriocin that exhibits antibacterial activity. C. maltaromaticum CB2 produces piscicolin 126, carnobacteriocin BM1, and may produce one or more additional uncharacterized bacteriocins. C. maltaromaticum CBS produces piscicolin 126, carnobacteriocin BM1, and may produce one or more additional uncharacterized bacteriocins.

The compositions and methods of the present invention include the use of one or more natural bacterial cultures, homologous pasteurized or unpasteurized fermentate, heterologous pasteurized or unpasteurized fermentate or combinations thereof. The natural bacterial cultures of the present invention are described above. A homologous fermentate refers to the culture supernatant of a single bacterial culture prepared according to standard preparation techniques. A heterologous fermentate refers to the culture supernatant derived from a different bacterial culture prepared according to standard preparation techniques. The homologous or heterologous fermentate may be i) pasteurized or unpasteurized; ii) lyophilized; or iii) otherwise dried, Two or more bacterial cultures may be mixed or added separately. Two or more fermentates may be mixed or added separately. A bacterial culture combined with one or more fermentates may be mixed, or added sequentially.

An important aspect of the present invention comprises the use of the bacterial fermentate in the preservation and treatment of fresh meats. In accordance with the teachings of the present invention, the bacteriocins produced by strains CB1, CB2, or CB3 appear to act synergistically to provide greater protection and effectiveness than use of the individual bacteriocins alone.

As used herein, fresh meat products refer to raw or uncooked meat (stored under refrigerated conditions) that may or may not contain additional spice mixtures, and includes integral or ground meat. Processed meat products refer to meats that have been i) formulated and cooked; ii) cured; or iii) uncured to produce a marketable product, “Fresh” and “processed” are intended to be used in their ordinary meaning as known to those skilled in the art. Typical meats include, but are not limited to, wieners, sausage, fish, and poultry.

The compositions and methods of the present invention may also be used to treat other food products including, but not limited to, modified atmosphere packaged vegetables, vacuum-packed pasta and fresh pasta products.

As used herein, predicted storage life refers to the capability of controlling spoilage for a discrete period, at which point spoilage becomes evident. For example, bacteria can be applied to a food product to attain a storage life of about 10 weeks or greater, at which point spoilage may be detectable. Within the 10-week storage period, the composition of the present invention controls spoilage by one or more of the following ways: i) by applying bacteria having a known time to spoilage; ii) by applying bacteria that produce one or more proteins or bacteriocins that kill or control spoilage bacteria; or iii) by combinations thereof.

As used herein, enhanced safety refers to the inhibition of growth and/or the reduction of numbers of potentially pathogenic bacteria, ranging from bactericidal to bacteriostatic.

As used herein preservation of color refers to the extension of the time that the food product retains its desirable coloration. This concept is well known to those skilled in the art.

### EXAMPLES

### Example 1

Collins et al. (1987) reported that L. piscicola, L. divergens and L. carnis synthesize the major C18:1 isomer as oleic acid (Δ9, 10), indicative of a different unsaturated fatty acid synthase pathway. Genetic homology classifications and chemical as well as physical characteristics also placed L. piscicola, L. carnis and L. divergens in the same DNA homology group. In addition, biochemical and chemical data indicated that L. piscicola and L. carnis should be (and were) reduced to the same species, L. piscicola, L. piscicola, along with L. ivergens, were then re-classified into a new genus, Carnobacterium (L. gen. N. carnis, of flesh; Gr. dim, n. bakterion, a small rod; M.L. neut. N. Carnobacteruim, flesh rodlet) by Collins et al. (1987). This was further substantiated when a 16S rRNA sequence analysis demonstrated that the Carnobacterium genus forms a distinct phylogenetic clade4 within the lactic acid bacteria and included C. funditum, C. alterfunditum, C. gallinarum and C. mobile (Table 1), with Lactobacillus maltaromaticus further defined as an objective synonym of Carnobacterium piscicola (Miller et al., 1974; Collins et al., 1991; Lai and Manchester, 2000; Lai et al., 2004). In addition, although the Carnobacterium spp. were originally classified with the lactobacilli, phylogenetically the genus is more closely related to the genera Enterococcus and Vagococcus (Hiu et al., 1984).

Subsequent phenotypic and genetic characterizations of Lactobacillus maltaromicus strains DSM 20342T, DSM 20344 and JCM1154 determined that these strains also belonged in the genus Carnobacterium. Further comparison with C. piscicola resulted in the decision that these two species should be considered synonymous. As a result, C. piscicola was reclassified as Carnobacterium maltaromaticum comb. nov. (Collins et al. 1991; Mora et al., 2003). Therefore, the common name of Carnobacterium maltaromaticum will be used in reference to the species of the present invention.

TABLE 1
Carnobacterium species, their relationship to previously
described bacteria and their habitat (Collins et al.,
1987; Collins et al., 1991; Mora et al., 2003).

| Current | Previous | |
|---|---|---|
| nomenclature | nomenclature | Habitat |
| C. divergens | L. divergens | Meat, poultry, |
| | | surface of |
| | | ripened |
| | | mold cheeses |
| C. gallinarum | | Poultry |
| C. mobile | | Poultry |
| C. | L. piscicola | Meat, poultry |
| maltaromaticum* | | or salmonid fish |
| | L. carnis | |
| | L. maltaromicus | |
| C. funditum | | Antarctic lake |
| C. alterfunditum | | Antarctic lake |

*Proposed as C. maltaromicus(Collins et al., 1991) and C. maltaromaticum (Mora et al., 20
C. = Carnobacterium;
L. = Lactobacillus.

### Example 2

Naturally-occurring C. maltaromaticum historically belongs to a group of LAB that metabolize glucose heterofermentativety to produce equimolar amounts of lactic acid, carbon dioxide and ethanol or acetic acid from sugars and was previously included in the genus Lactobacillus (Stanier et al., 1957; Hiu et al. 1984). Although some research has indicated that Carnobacterium spp. are homofementative for L-lactate [with acetate, formate and CO₂ being produced as end-products of some secondary decarboxylation/dissimilation reactions of pyruvate (Hiu et al. 1984; De Bruyn et al., 1988)], the most recent description and characterization of C. maltaromaticum states that L(+)-lactic acid, ethanol and acetate are produced heterofermentatively (Mora et al., 2003). Therefore, for this example, C. maltaromaticum has been characterized as having heterofermentative properties. C. maltaromaticum was found frequently in fish that had suffered some form of stress, such as that which occurs at spawning or with handling (Hiu et al., 1984; Baya et al., 1991). C. maltaromaticum has also been found by Ringo et al. (2000) to be associated with the digestive tract of the Atlantic salmon (Salmo salar L.). Carnobacteria have been isolated from refrigerated, vacuum-packaged fish and unprocessed beef and lamb, where it was among the predominant

LAB on the meats (Ahn and Stiles, 1990a; Baya et al., 1991; Barakat et al., 2000; Carr et al., 2002; Paludan-Muller et al., 1998; Sakata et al., 2002; Yamazaki et al., 2003). The methods used in these studies did not enrich or select for any specific bacterial class or species.

A biochemical and physiological comparison between C. divergens and C. maltaromaticum is given in (Table 2). C. maltaromaticum strain B270T was described as having the following characteristics (Hiu et al., 1984; Collins et al., 1987).
Gram-positive, non-motile, non-spore forming rods that occur singly and in shod chains;
Grows well on many standard laboratory media, including TSA (Trypticase Soy Agar) and Brain Heart Infusion agar and in deMan, Rogosa and Sharpe (MRS) broth and thioglycolate broth;
Colonies are pinpoint, convex, white, circular and non-pigmented when grown at 25° C. for 24 h on TSA;
Temperature range for growth is 6° C. to 40° C.; optimum temperature is approximately 30° C.;
Optimum pH range is from 6.0 to 7.0;
Facultatively anaerobic. D, L-lactate is produced homofermentatively, but the species may exhibit heterofermentative properties under certain conditions; lactic acid production is enhanced under anaerobic growth conditions;
Folic acid, riboflavin, pantothenate and niacin are required for growth; vitamin B12, biotin, thiamine and pyridoxal are not required;
Catalase and oxidase are not produced;
Nitrate is not reduced to nitrite;
Gas production is variable (depending on substrate) and frequently negative; gas production from glucose in arginine-MRS broth;
Acid is produced from glycerol, ribose, galactose, gluconate, glucose, fructose, mannose, mannitol, N-acetyl glucosamine, amygdalin, arbutine, salicin, cellobiose, sucrose and trehalose; acid is not produced from arabinose, xylose, sorbose, rhamnose, dulcitol, inositol, methyl-D-mannoside, inulin or melezitose;
Arginine and esculin are hydrolyzed;
H₂S is not detected in TSI (Triple Sugar Iron Agar) slants;
Resistant to 0.4 and 0.6% Teepol;
Cell wall peptidoglycan contains diaminopimelic acid;
DNA G+C content is 33.7-36.4 mol %;
Major cellular fatty acids are of the straight-chain saturated and mono-unsaturated types with myristic, palmitic, palmitoleic and Δ9, 10-oleic acids predominating;

The type strain is B270T (ATCC 35586), isolated in 1970 from a stressed adult cutthroat trout reared at Bandon Trout Hatchery in Coos County, Oreg.

TABLE 2
Biochemical and physiological comparison
of the Carnobacterium species¹.

| Characteristic | C. divergens | C. maltaromaticum² |
|---|---|---|
| Acid producted from³: | | |
| Amidon | − | − |
| Amygdalin | + | + |
| Galactose | − | + |
| β-Gentiobiose | + | + |
| Gluconate | +(−)⁴ | + |
| Inulin | − | + |
| Mannitol | − | + |
| Melibiose | − | + |
| Melezitose | +(−) | +(−) |
| α-Methyl-D-glucoside | − | + |
| α-Methyl-D-mannoside | − | + |
| D-Tagatose | − | +(−) |
| D-Turanose | − | − |
| D-Xylose | − | − |
| Voges-Proskauer⁵ | + | + |
| Motility | − | − |
| Δ9,10- | + | − |
| Methyleneoctadecanoic acid⁶ | | |

¹Adapted from (Collins et al., 1987).
²Previously designated as Lactobacillus piscicola and Carnobacterium piscicola;
³Reading performed at seven days.
⁴+(−) = Occasional strain negative;
⁵Glucose metabolism test performed on API 10E system; both strains produced arginine dihydrolase and β-galactosidase; both strains were negative for lysine decarboxylase, tryptophan desaminase, urease, ornithine decarboxylase, indole and H2S;
⁶Greater than 15% of total cellular fatty acids.

Alkaline pH (up to pH 9.5) promotes the growth of Carnobacterium colonies, while inhibiting other Lactobacillus species. Differentiation of C. maltaromaticum from other bacteria may be accomplished by modification of growth substrates. Differentiation of C. maltaromaticum from the enterococci includes microscopic distinction of rods vs. cocci and growing on Cresol Red Thallous Acetate Sucrose (CTAS) medium containing 2% inulin instead of sucrose. Enterococci are not able to ferment inulin, while C. maltaromaticum ferments inulin, forming yellowish to pinkish colonies with a metallic bronze sheen, a yellow color change of the medium and a clearance of precipitate. C. maltaromaticum forms an umbolate or beta-type colony when inosine is substituted for sucrose in CTAS Agar. The enterococci also produce a yellowing of the medium and a clearing of the precipitate, but do not have a metallic sheen (Carr et al., 2002). Different strains of C. maltaromaticum have been shown to produce bacteriocins (Ribosomally synthesized, low molecular weight, antibacterial, proteinaceous materials that are able to inhibit the growth or kill closely related bacteria) that inhibit the growth of Lactobacillus, Listeria and other Carnobacterium species (McMullen and Stiles, 1996; Duffes et al., 1999c; Schillinger et al., 1993).

### Example 3

The strains specified in this GRAS document (e.g., Carnobacterium maltaromaticum strains CB1, CB2, CB3, LV17, UAL26, ATCC 35586 AND ATCC43225) have been tested for their resistance to 27 antibiotics (Table 3; Griffiths Labs, 2004). Overall, the C. maltaromaticum strains tested were sensitive to amoxicillin+clavulanic acid, chloramphenicol, ciprofloxacin, erythromycin, gentamicin, imipenem, netilmicin, rifampin, tetracycline and tobramycin. In viewing the antibiotic resistance profiles (Table 3), the Carnobacterium strains are sensitive to those major antibiotics that are commonly associated with transferable genetic elements in gram positive commensal bacteria, specifically, erythromycin, chloramphenicol and tetracycline. Borriello et al. (2003) suggested that when used as probiotics, selected strains should be susceptible to greater than two major antibiotics. A comparison with the antibiotics used by Baya et al. (1991), Duffes et al., (1999b) or Euzeby (2004) indicate that the sensitivity of the C. maltaromaticum strains (CB1, CB2, CB3, LV17, UAL26, ATCC 35586 and ATCC43225) to various antibiotics correlate well with antibiotic resistance found in C. maltaromaticum strains isolated from natural fish sources, as noted in Table 3. The antibiotic resistance profile for the C. maltaromaticum strains specified in this GRAS dossier correlate well with the antibiotic resistance profiles of Lactobacillus species already being added to food or found in food naturally. This indicates that the addition of these strains of C. maltaromaticum to foods would not be adding any new or significant antibiotic resistance determinants that are not normally found in commensals or probiotic lactobacilli.

TABLE 3

| | | | | | | | | | | Duffes |
|---|---|---|---|---|---|---|---|---|---|---|
| | | | | | UAL | ATCC | ATCC | Baya et | Euzby, | et al., |
| Antibiotic | CB1 | CB2 | CB3 | LV17 | 26 | 35586 | 43225 | al., 1991 | 2004 | 1999b |
| Amikacin | R | R | R | I | R | R | R | | | R |
| Amoxicillin + | S | S | S | S | R | R | S | | | S |
| clavulanic acid | | | | | | | | | | |
| Aztreonam | R | R | R | R | R | R | R | | | R |
| Cefepime | R | R | R | R | R | R | R | | | R |
| Cefotaxim | R | R | R | R | R | R | R | | | R |
| Ceftazidime | R | R | R | R | R | R | R | | | R |
| Cefuroxime | R | R | R | R | R | R | R | | | R |
| Chloramphenicol | I | I | S | S | I | S | S | R | S | S |
| Ciprofloxacin | I | S | S | S | I | S | S | | | S |
| Clindamycin | R | R | R | R | R | R | R | | | R |
| Colistin | R | R | R | R | R | R | R | | | R |
| Erythromycin | I | I | S | I | I | I | I | S | R | S |
| Gentamicin | I | R | S | I | R | S | I | R | | R |
| Imipenem | S | S | S | S | S | S | S | | | S |
| Kanamycin | R | R | I | R | R | I | R | R | | R |
| Minocycline | P | P | P | P | P | P | P | | | |
| Moxolactam | P | P | P | P | P | P | P | | | R |
| Nalidixic acid | R | R | R | R | R | R | R | R | | R |
| Netilmicin | I | S | S | S | I | S | S | | | |
| Piperacillin | R | R | R | R | R | R | R | | | S |
| Rifampin | I | I | S | S | I | S | S | | | S |
| Streptomycin | R | R | R | R | R | R | R | | R | R |
| Tetracycline | S | I | S | I | I | S | S | S | S | S |
| Ticarcillin | R | R | R | R | R | R | R | | | S |
| Tobramycin | S | S | S | S | S | S | S | | | R |
| Vancomycin | R | S | R | S | R | R | R | | | S |

### Example 4

### Occurrence and use of Lactic Acid Bacteria in Food

Using direct-plating methods to identify bacteriocin-producing LAB isolates from meat and meat products, milk and dairy products, vegetables, fruit and seafoods, a total of 663,533 colonies from 72 food samples (32 milk and dairy, 40 meat) were examined for bacteriocin production (Coventry et al, 1997). Many of these food samples were judged to have exceeded an acceptable shelf life. A total of 15% of the meat and meat products yielded bacteriocin producing Carnobacterium spp. Of the 72 food samples investigated, 44% yielded bacteriocin producing bacteria. From the total 663,533 colonies tested, 80,992 colonies (12.2%) were found to be Carnobacterium spp., with 0.15% of those producing bacteriocins. The antibacterial activities of filter-sterilized culture supernatant fluids from select strains of the bacteriocin producers were not affected by catalase, lipase or lysozyme, but were either completely or partially inactivated by at least one of the proteolytic enzymes, indicating that antibacterial activity was associated with proteinaceous substances. This study also shows that humans are already being exposed to Carnobacterium spp. and other food-borne bacteria that produce bacteriocins.

Amezquita and Brashears (2002) report the isolation of 49 strains of LAB from commercially available ready-to-eat (RTE) meat products. These were screened for their ability to inhibit the growth of Listeria monocytogenes at 5° C. on agar spot tests. Pediococcus acidilactici, Lactobacillus casei and L. paracasei were identified as the three species with the greatest inhibitory activity. There was significant inhibition (P<0.05) of the growth of L. monocytogenes in all of the RTE meat products evaluated (five commercial samples of cooked ham and five commercial samples of frankfurters), when three selected strains of Pediococcus acidilactici, Lactobacillus casei and L. paracasei were added to the RTE meat products. This study showed that select strains of LAB can be isolated from RTE meat products and these strains effectively inhibit the growth of L. monocytogenes in frankfurters and cooked ham at 5° C. over 28 days of storage. During the time of storage, the numbers of LAB increased by only approximately 1 log cycle and no visible signs of spoilage were evident (e.g., detrimental effect on some organoleptic properties related to external appearance such as color changes, undesirable aromas and stickiness or texture changes) on the surface of the products. A study conducted by Sakata et al. (2002) to investigate the psychrotrophic (Bacteria which are able to grow at refrigeration temperatures, but grow optimally at temperatures above 20° C.) spoilage microflora on refrigerator-stored, vacuum-packaged beef. This study utilized a less selective glucose-blood-liver agar and Trypticase Soy Agar plating method (allowing for the widest range of bacterial growth) at an incubation temperature of 7° C. Various psychrotrophic species on vacuum packaged beef stored at refrigeration temperatures were identified and quantified over a six-week period to determine alterations in the bacterial species or quantities of the bacteria. Five fresh beef cut samples (acquired and vacuum-packaged approximately 48 hours after slaughter) were utilized to determine the types and quantities of the various bacteria found in vacuum-packaged beef. A total of 1493 bacterial strains were identified as: Brochothrix thermosphacta (64), Carnobacterium maltaromaticum (27), C. divergens (79), Lactobacillus algidus (637), Lactobacillus spp. (4), Lactococcus piscium (270), Leuconostoc gelidum (375), Acinetobacter (3), Aeromonas (1), Bacillus (10), Corynebacterium (3), Enterobacteriaceae (1), Pseudomonas (113) and Psychrobacter (6). L. gelidum, L. piscium and L. algidus increased during the first three weeks of storage from approximately 5×10³ cfu/g to approximately 1×10⁸ cfu/g, and remained stable for the rest of the six-week study. C. maltaromaticum was inconsistently detected, but when present increased to approximately 5×10⁷ cfu/g during the first three weeks of storage and remained at that level for the last three weeks of the study. Vacuum or modified atmosphere (CO₂) packaging (CO₂-MAP) influences the bacterial species isolated from meat (Labadie, 1999). At low temperatures and with a limited amount of oxygen, LAB comprise the predominant bacterial population of CO₂-MAP packaged meat, at approximately 1×10⁷ cfu/cm² (Gilt and Newton, 1978). There have been no studies directly comparing the specific quantities of different species of Lactobacillus, Leuconostoc and Carnobacterium on freshly packaged meat under CO₂-MAP conditions. Nilsson et al. (1999) isolated 2×104 and 5×10⁷ cfu/g LAB from cold-smoked salmon at the time of purchase and after thirty-two days of incubation, respectively.

### Example 5

### Natural Occurrence of Carnobacterium maltaromaticum on Meat, Fish and Cheese Products

Carnobacterium species have been isolated from vacuum-packaged meat, fish and French soft cheese (Ahn and Stiles, 1990a; Buchanan and Klawitter, 1992b; Stoffels et al., 1992; Pilet et al., 1995; Milliere and Lefebvre, 1994a; Milliere et al., 1994b), as summarized in Table 4. A study by Lewus et al. (1991) identified two bacteriocin-producing strains of C. maltaromaticum from different parts of meat from retail meat products. Other C. maltaromaticum strains have been isolated from fish, meat and cheese (Milliere et al., 1994b; Nissen et al., 1994; Pilet et al., 1995; Schillinger et al., 1993; Shaw and Harding, 1984). Leisner et al. (1994) found that eighteen of the 80 strains of bacteria originally isolated from vacuum-packed halibut, salmon or mackerel were lactic acid bacteria. Of these, 28% were identified as C. maltaromaticum. Sakala et al. (2002) conducted a study to investigate the psychrotrophic spoilage microflora on chill-stored vacuum-packaged beef and determined that out of a total of 1493 strains isolated from five fresh beef cut samples (each from a different meat shop), twenty-seven were identified as C. maltaromaticum. This bacterium was detected at 0, 1, 3, 5 and 6 weeks of storage at mean numbers of 2×10³, 2×10⁴, 2.5×10⁶, 1×10⁷ and 2.5×10⁷ cfu/g, respectively, for two samples positive for C. maltaromaticum and, persisted at the level of approximately 5×10⁷ cfu/g during the last three weeks of the six-week storage period.

The growth of C. maltaromaticum in fermented meat products has been noted by Montel (1999), who noted “At the end of the fermentation period, lactic acid bacteria are generally the dominant bacterial flora. The species Lactobacillus curvatus, L. sakei, L. plantarum, L. viridescens, Carnobacterium divergens, C. maltaromaticum and Leuconostoc are present naturally, but Pediococcus is only found when inoculated as a starter culture. Their count generally exceeds 10⁶ cfu/g and remains at this level during the whole ripening period. Carnobacterium is present during the fermentation period, but disappears afterwards.”

TABLE 4
Isolation of C. maltaromaticum from food products.

| | | C. | |
|---|---|---|---|
| Food | | maltaromaticum | |
| Catageory | Food Product | strain* | Reference |
| Fish | Cultured striped bass, | | (Baya et al., 1991) |
| | channel catfish and | | |
| | bullhead catfish | | |
| | Cold-smoked | | (Gonzalez- |
| | freshwater fish | | Rodriguez et |
| | | | al., 2002) |
| | Salmonid fish | | (Hiu et al., 1984) |
| | Cold-smoked salmon | | (Leroi et al., 1998) |
| | Vacuum-packaged | | (Lesner et al., 1994) |
| | halibut, salmon | | |
| | or mackeral | | |
| | Cold-smoked salmon | A9a, A9b, A9c, | (Paludan-Muller |
| | | A9J, A10a, A10b, | et al., 1998) |
| | | A10f, A10J, S1, | |
| | | S2, S3, S4 | |
| | Fish | V1 | (Pilet et al., 1995) |
| Beef | Vacuum-packaged | | (Ahn and |
| | beef | | Stiles, 1990a) |
| | Raw ground beef | | (Buchanan and |
| | | | Klawitter, 1992A) |
| | Meat | GN, DX | (Lewus et al., 1991) |
| | Vacuum-packaged | | (Sakala et al., 2002) |
| | beef | | |
| | Meat | LV 61 | (Shaw and |
| | | | Harding, 1984) |
| Lamb | Modified atmosphere- | | (Nissen et al., 1994) |
| | packaged lamb | | |
| Chicken | Modified atmosphere- | | (Bakarat et al., 2000) |
| | packaged chicken legs | | |
| | Poultry | | (Collins et al., 1987) |
| Dairy | Soft cheeses | CP5 | (Milliere et al., 1994B) |

*= Strain given, if known.

Cold-smoked salmon (CSS) is an extremely perishable food product and is highly susceptible to contamination with Listeria monocytogenes. CSS spoilage is primarily due to microbial activity during refrigerated storage (Duffes, 1999a). For CSS, it has been estimated that immediately after packing, bacterial counts range from 1×10³ to 1×10⁴ cfu/g with a predominance of Gram-negative bacteria (64%) such as Shewanella putrefaciens and Aeromonas spp. LAB were found to be present (32%), with the majority being Carnobacterium spp. (Donald and Gibson, 1992; Huss et al., 1995). At 8° C., the level of bacterial flora increased to 1×10⁷-1×10⁸ cfu/g over three weeks, with a shift in relative bacterial populations such that LAB predominate (60%), mainly as Carnobacterium spp. (47%) and Lactobacillus spp. (13%). Paludan-Muller et al., (1998) reported a series of studies that evaluated the role of C. maltaromaticum in spoilage of vacuum- and modified-atmosphere-packed cold-smoked salmon stored at 5° C. A mixture of LAB and Gram-negative bacteria are usually found on spoiled CSS.

Initial numbers of bacteria were low with total psychrotrophic counts less than 5×10³ cfu/g and, specifically, LAB counts of 10-1×10² cfu/g. In addition, it was determined (by sensory evaluation) that the shelf life of vacuum-packed cold-smoked salmon peaked at four weeks at 5° C. The microflora at four weeks was composed of LAB (1×10⁶-1×10⁷ cfu/g) with Gram negative microflora at varying levels (1×105-1×10⁷ cfu/g).

Modified-atmosphere packaging reduced the growth of Gram-negative bacteria and selected specifically for LAB, although growth of LAB was below 3×10⁵ cfu/g during five weeks of storage (Paludan-Muller et al., 1998). The LAB microflora was dominated by C. maltaromaticum, accounting for 87% of the 255 LAB isolates characterized. The spoilage potential of C. maltaromaticum was further studied by inoculation of approximately 1×10⁶ cfu C. maltaromaticum per gram in CSS stored at 5° C. (Paludan-Muller et al., 1998). In vacuum packed salmon inoculated with C. maltaromaticum strains, LAB counts reached 1×10⁷ cfu/g after only one week of storage and the level was above 1×10⁸ cfu/g for the rest of the storage period. However, after four weeks of storage, the salmon was not rejected by a sensory taste panel, while the vacuum-packed control was rejected after four to five weeks. In inoculated modified atmosphere-packed salmon, the LAB counts reached final levels of 1×10⁶-1×10⁷ cfu/g after two weeks, but the salmon was not sensory-rejected until four to five weeks of storage. It was concluded that the growth of C. maltaromaticum even at high numbers (1×10⁷-1×10⁸ cfu/g) for several weeks did not accelerate the spoilage process of packed cold-smoked salmon.

A bacterial study on the composition of the psychrotrophic and mesophilic microflora of French surface-mold-ripened soft cheeses made from raw cow's milk found that C. maltaromaticum was the dominant bacteria at the end of ripening on five samples of Brie cheese (Milliere and Lefebvre, 1994a). C. maltaromaticum bacteria was also isolated from Coulommiers, Camember. Pon-l'Eveue and Munster cheeses. The number of Carnobacterium colonies isolated from these cheeses ranged from 5×10⁵ to 8×10⁸ cfu/g in the various cheese samples. Milliere et al. (1994b) went on to characterize C. maltaromaticum strains isolated from five samples of Brie cheese. The pH values of the cheeses were between 6.8 and 7.6 and no off-odors or organoleptic defects were noted. The Carnobacterium species were dominant in the cheese samples, at between 1×10⁸ and 1×10⁹ cfu/g. The results of DNA-DNA hybridizations indicated that 33 of the 36 isolates were of the C. maltaromaticum species, while the remaining three (all picked from the same sample) were C. divergens.

To summarize, Carnobacterium spp. are common components of the microflora on vacuum-packaged meat, poultry, fish and cheese products and in some cases, they can represent a predominant constituent population, reaching levels of 1×10⁸ cfu/g or higher, on products such as smoked fish, chicken, beef and cheese, without causing detectable spoilage.

### Example 6

### Production of Carnobacterium maltaromaticum Culture

C. maltaromaticum m strains are maintained in lyophilized form under vacuum at 4° C., or as frozen cultures in 20% (v/v) glycerol at −80° C. API® strip analysis (a kit for identification of bacteria to the species level) is conducted to ensure viability and strain purity will be confirmed by the absence of bacteriological contamination and/or by random amplified polymorphic DNA (RAPD) and microbiological analysis. Seven lyophilized vials are prepared for each strain (master seed). From a single vial of the master seed, 15 lyophilized vials are prepared under vacuum and stored at 4° C. (secondary seed). From each vial of the secondary seed, enough frozen vials are prepared for one year's production requirements and stored at

−80° C. One out of every 10 vials undergoes microbiological testing to confirm strain purity and the absence of bacteriological contamination.

Seed and Mother Culture: The seed culture is prepared by transferring a loop full of frozen master seed or a vial of lyophilized culture to 10 ml APT (All Purpose Tween). The seed is then grown overnight. The mother culture is prepared from the seed culture by transferring the seed culture (grown overnight) into 6 L of APT medium and incubated again overnight.

Fermentation and Concentration: The mother culture is aseptically transferred to the production fermentor, which contains a growth medium and was maintained at 25° C. The fermentation is monitored spectrophotometrically (650 nm) and by plating onto APT agar until a cell density of approximately 10⁹ cfu is reached. The fermented growth medium (containing C. maltaromaticum) is then harvested and freeze-dried.

Lyophilization: The lyophilized material is scraped from the trays, ground and milled, and placed into polyethylene bags and double-bagged prior to refrigeration (4-8° C.).

### Example 7

### Microbiological Analysis

The lyophilized material is analyzed microbiologically for total lactic acid bacteria, non lactic acid bacteria, yeast, molds, total coliforms, Staphylococcus aureus, Escherichia coli and Salmonella spp. (Table 5).

TABLE 5
Specifications of Carnobacterium maltaromaticum
lyophilized bacterial powder.
Active Ingredients Carnobacterium maltaromaticum
Excipients Maltodextrin
Shelf Life > one year
Storage Conditions Room Temperature (22° C.)

| Physical Aspects | Specifications | Method |
|---|---|---|
| Appearance | Pass | Visual inspection |
| | | APT plate and |
| | | comparison to |
| | | standard plate |
| | | photograph and |
| | | description |
| Concentration | Between | A.P.H.A./USP |
| | 3.2 × 10⁶/g and | |
| | 3.2 × 10⁷ | |
| | viable cells/g | |
| Residual Moisture | <5% | O'Haus |
| Microbiological | | |
| Specifications | | |
| Lactic Acid Bacteria | Between | A.P.H.A./USP |
| | 3.2 × 10⁶/g | |
| | and | |
| | 3.2 × 10⁷ cfu/g | |
| | or between | |
| | 1.3 × 10⁹ | |
| | and 1.4 × 10¹⁰ | |
| | cfu/package | |
| Non Lactic acid bacteria | <100/g | A.P.H.A./USP |
| Yeasts | <100/g | A.P.H.A./USP |
| Molds | <100/g | A.P.H.A./USP |
| Anaerobic Spore | <10/g | A.P.H.A./USP |
| Forming Bacteria | | |
| Clostridium botulinum | Absent per 50 g | A.P.H.A./USP |
| Total coli forms | <10/g | A.P.H.A./USP |
| Staphylococcus aureus | <100/g | A.P.H.A./USP |
| E. coli. | Absent per 25 g | A.P.H.A./USP |
| Salmonella spp. | Absent per g | A.P.H.A./USP |

A.P.H.A. = American Public Health Association;
USP = U.S. Pharmacopoeia

### Example 8

### Reconstitution of Starter Culture

The standardized viable cell blend will be packaged into plastic foil film packages, flushed with nitrogen and package weight will be customized to the finished product application such that between 10³ and 10⁴ viable C. maltaromaticum cells per gram of finished product will be achieved. The packages will then be stored at ambient temperature.

The packaged standardized viable cell blend will be analyzed microbiologically for identity, total lactic acid bacteria, non lactic acid bacteria, yeasts molds, total coliforms, Staphylococcus aureus, Escherichia coli and Salmonella spp. (Table 5).

A dose of reconstituted C. maltaromaticum, containing one or more of strains CB1CB2, CB3, LV17, UAL26 , ATCC 35586 or ATCC 43225 (approximately 1×10³ to 1×10⁴ cfu/g of finished product) may also be added directly to ground meat prior to ingredient mixing and further grinding and stuffing into casings. The sausages would then be rapid frozen at −50° C. until frozen in the center. These sausages would then be wrapped airtight in plastic wrap and kept frozen until thawed for retail sale.

### Example 9

### Growth Characteristics of Carnobacterium maltaromaticum on Vacuum-Packaged Wieners

A laboratory-scale study was designed to investigate the growth characteristics of C. maltaromaticum on vacuum-packaged wieners inoculated with C. maltaromaticum under conditions comparable to commercial production. In addition, the effects on sensory properties, such as aroma and flavor profile, were investigated. The methods and results of this study were as follows:

Two strains of C. maltaromaticum were chosen for study: LV17 (a synonym for UAL 8) was originally isolated from vacuum-packaged, refrigerated, fresh pork and described by Shaw and Harding (1984) and, strain UAL 26, which was isolated from vacuum-packaged beef (Stiles and Holzapfel, 1997). The inoculum was prepared by adding washed bacterial cells to sterile 0.85% saline to provide an inoculum level of 2.5×10⁶ cfu/ml. Individual wieners were dipped into the inoculum suspension for one minute, drain dried and vacuum-packaged in groups of five wieners per bag (high barrier, low O₂ transmission, VP bags). As a control, wieners were dipped in 0.85% sterile saline without bacterial inoculum. Treated and control samples were then placed into refrigerated (4° C.) storage for up to 12 weeks. Sampling of the wieners for microbiological analyses and sensory evaluation was performed on day zero and after 2, 4, 6, 7, 8, 10 and 12 weeks of storage.

Samples were prepared for microbial analysis by cutting 1.8 cm length piece of wiener (equivalent to a surface area of 10 cm²), placing it in a sterile tissue homogenizer bag and homogenizing. Bacterial counts were conducted by standard dilution and plating techniques and included: 1) Total aerobic plate count on Plate Count Agar incubated aerobically at 25° C., 48 hours; 2) Lactic acid bacteria on APT agar incubated anaerobically at 25° C., 48 hours; 3) Enterobacteriaceae on Violet Red Bile Agar with one percent added glucose incubated at 35° C., 18 hours. Concentrations of bacteria were reported as cfu per cm² of product (cfu/cm²).

The wieners to be evaluated for sensory characteristics were cooked in “just boiled” water and allowed to stand for five minutes (internal wiener temperature approximately 83° C.). Wieners were cut into pieces, placed in coded foil-covered jars and heated for 15 min in a 94° C. oven just prior to evaluation. Sensory evaluation was conducted by a group of nine panelists trained over a three-month period. Samples were evaluated for overall aroma intensity, meat flavor intensity, seasoned flavor, smoke intensity, sourness/acidity, off-flavor and overall acceptability using a 15 cm unstructured line scale with 0=very bland and 15=very strong. Between samples, palates were cleansed with crackers and a 1:1 dilution of 7-Up®.

This study reported that sample wieners that had been inoculated with C. maltaromaticum strains LV17 or UAL 26 reached maximum anaerobic lactic acid bacteria (LAB) counts of 2.75×10⁶ and 1.2×10⁵ cfu/cm² after seven or eight weeks of cold storage, respectively. C. maltaromaticum grew at a slow rate on vacuum-packaged wieners and growth was accompanied by a relatively small decrease in surface pH during storage. LV17 varied from pH 6.2 at Week 0 to pH 6.1 at Week 10, while UAL 26 varied from an initial pH 6.2 to approximately 5.9 during Weeks 6-8 and Week 12).

It was concluded that in comparison with other lactic acid bacteria, such as L. gelidum, C. maltaromaticum is a slow-growing species when inoculated onto refrigerated (4° C.), vacuum packaged wieners. The levels of C. maltaromaticum reached a maximum of 5×10⁷ cfu/cm² after 12 weeks of cold storage. Based on sensory evaluations using a trained nine-member panel over the 12-week storage period, there were no significant adverse effects on aroma, off-flavors, sour intensity, or overall acceptability resulting from inoculation with C. maltaromaticum.

### Example 10

### Growth Characteristics of Carnobacterium maltaromaticum when Inoculated into Sausages

C. maltaromaticum CB1 was added to pork in three trials as an inoculate during the production of sausages. Odor intensity and freshness attributes for the sausages (evaluated as both raw and cooked) were treated on a 21-point line scale. Inoculum levels ranged from 1×10³ to 1×10⁵ cfu/g of meat. Bacteriological analyses were conducted on Days 0, 5, 10, 15 and 20 to assess the growth of C. maltaromaticum and bacteriocin production.

Chilled pork shoulder and pork fat were weighed, coarse ground and divided into four batches to which 2.76% water and 1.8% of seasoning were added. Test product was inoculated with C. maltaromaticum up to 10⁵ cfu/g. The ground meat and ingredients were mixed, ground fine and stuffed into collagen casing (UniPac, Edmonton). The stuffed casing was cut into links 3.5-3.75 inches, to give sausages that were approximately 20.4 g/sausage. The individual sausage links were rapid frozen at −50° C. for approximately 35 minutes. The frozen sausages were packaged on Styrofoam trays (approximately 10 oz per pack) and airtight wrapped and sealed in plastic wrap. The samples were thawed and stored at 4° C. prior to bacterial sampling.

Usual manufacturing procedures for meats include the procedure of “flash freezing” meat for shipment, with subsequent thawing for sale or further processing.

Bacteriological sampling was done on samples that had been thawed and stored at 4° C. for 0, 5, 10, 15 and 20 days. Duplicate 10 g samples were placed into sterile stomacher bags (VWR International) and blended with 90 ml of sterile 0.1% peptone water. Appropriate serial dilutions in 0.1% peptone water were streaked onto prepoured APT agar and MRS agar plates and incubated at 30° C. for 48 h. Duplicate counts (cfu/g of meat) were recorded for each sample after the incubation period.

Over a 20 day period, total anaerobic bacterial counts on MRS agar increased from 10³-10⁵ cfu/g, up to 10⁹ cfu/g of product. The growth of background microflora in the test product did not differ from that associated with un-inoculated samples, as evidenced by the growth on APT agar. This indicates that the inoculation of the sausage meat with C. maltaromaticum did not increase the overall incidence of bacterial growth in the sausage. The microbiology assays indicated that the total number of bacteria growing on APT and MRS agar was similar on the uninoculated control and the test products. Therefore, added C. maltaromaticum cultures did not increase the number of bacteria found on the test products, nor cause the meat to spoil faster than the control.

Bacteriocin production in the sausage samples was tested at Days 0, 5, 10, 15 and 20 by direct and indirect assays and was detected, indicative of bacteriocin production by the added C. maltaromaticum. Suppression of the indicator organism, L. monocytogenes, was noted by Day 10 via the indirect assay [portions of the sausage were heat-treated (to kill the producer organism) and directly embedded into APT agar inoculated with L. monocytogenes CDC 7762 (serotype 4b)], with this suppression maintained through Day 20 of the assay. The direct assay for bacteriocin production (heat-treated supernatant of a homogenized sausage was directly added to APT agar plates overlaid with the L. monocytogenes indicator organism) in the sausages inoculated with C. maltaromaticum indicated that bacteriocin production occurred by Day 15 of sausage storage at 4° C. and continued through Day 20 of storage.

### Example 11

### Use of the Addition of Carnobacterium maltaromaticum in Ready-To-Eat and Fresh Comminuted, Processed Meat Products

RTE meat and fresh comminuted, processed meat products require preservation techniques that inhibit the growth of potentially pathogenic bacteria. A deadly Listeria monocytogenes outbreak recently spread across the northeast US, resulting in the U.S. Food and Drug Administration and the USDA's Food Safety Inspection Service (FSIS) issuing a health advisory in September, 2003 (Morbidity and Mortality Weekly Report, 2003).

It is proposed that C. maltaromaticum will be added to vacuum- or modified atmosphere packaged ready-to-eat (RTE) meat products and fresh comminuted, processed meat products as a means of mitigating the effects of contamination caused by human pathogenic bacteria, such as L. monocytogenes. During packaging of RTE meat products, such as wieners, it is proposed that a dose (approximately 1.5 ml, or 5×10⁶ cfu) of reconstituted C. maltaromaticum will be applied to each 454 g (1 pound) package.

An aliquot of reconstituted C. maltaromaticum (to deliver approximately 1×10³ to 1×10⁴ cfu/g) would also be added to fresh comminuted, processed meat products prior to ingredient mixing and further grinding and stuffing into casings to produce fresh comminuted, processed meat products. The fresh comminuted, processed meat products would be rapid frozen at −50° C. until frozen in the center, then wrapped airtight in plastic wrap and stored frozen.

The inoculation ranges for RTE meat products and fresh comminuted, processed meat products would be approximately 1×10³ to 1×10⁴ viable C. maltaromaticum cells (cfu) per gram of product.

### Example 12

Examination of the potential of a bacteriocin-producing strain of C. maltaromaticum (strain SF668) isolated from commercial, vacuum-packaged cold-smoked salmon (CSS) to inhibit L. monocytogenes growth on CSS by Duffes et al. (2000), found that C. maltaromaticum SF668 was able to grow from 1×10⁵ to 3×10⁷ cfu/ml in 21 days on vacuum-packaged, cold-smoked salmon stored at 4° C. (Table 8). L. monocytogenes co-cultured with C. maltaromaticum grew from 1×10³ cfu/ml to 3.5×10³ cfu/ml after three weeks at 4° C. This co-culturing of C. maltaromaticum with L. monocytogenes resulted in a significant bacteriostatic effect on L. monocytogenes growth on cold-smoked salmon (L. monocytogenes growth in the absence of C. maltaromaticum reached approximately 5×10⁴ cfu/ml).

When screened against 21 strains of Listeria spp., distinct zones of inhibition formed by C. maltaromaticum LK5 were evident with seventeen of the strains (Buchanan and Klawitter, 1992a). C. maltaromaticum LK5 was found to lack hydrogen peroxide formation, while producing a bacteriocin. The ability of C. maltaromaticum LK5 to inhibit Listeria spp. was temperature-dependent (determined at both 5° C. and 19° C.), with a substantially greater suppression of L. monocytogenes co-cultured with C. maltaromaticum LK5 occurring at 5° C. than at 19° C. C. maltaromaticum LK5 was shown to be capable of substantially faster growth than L. monocytogenes at refrigeration temperatures, whereas the growth rates were approximately the same at 19° C. At 19° C., suppression of L. monocytogenes (the inoculation concentration was kept constant at 1×10³ cfu/ml) was dependent on inoculum ratio, with only LK5:L. monocytogenes ratios of ≧1:1 producing a substantial degree of inhibition. At 5° C. an increased level of anti-listerial activity was observed with the higher inoculum ratios during the early stages of the incubation, but by approximately 300 h of incubation, LK5 inoculum size had no effect on inhibitory activity; the degree of suppression was equivalent for ratios ranging from 0.01:1 to 1000:1 (10:1×10³ and 1×10⁶:1×10³ cfu/ml, respectively).

The Carnobacterium isolate was extremely competitive at refrigeration temperatures, indicating that even small inocula could be used to controlL. monocytogenes in refrigerated foods. This study confirms the report by Schillinger and Holzapfel (1990), who reported that out of thirteen strains of C. maltaromaticum, ten significantly inhibited the growth of L. monocytogenes DSM 20600, as determined by the agar spot test.

### Example 13

### Background Exposure to Carnobacterium maltaromaticum

Studies have shown that lactic acid bacteria in general and, specifically C. maltaromaticum, are found in retail food products (modified-atmosphere packaging and refrigeration preferentially selects for anaerobic Carnobacterium spp.) within the expiration dates (Milliere and Lefebvre, 1994a; Kelly et al., 1996; Schobitz et all, 1999; Amezquita and Brashears, 2002; Sakala et al., 2002). Therefore, for an accurate assessment of the numbers of C. maltaromaticum that could maximally be consumed, one must take into account any theoretical amount of C. maltaromaticum that may already be present on the proposed foods.

An extensive search of the literature resulted in two references specifically analyzing the quantity of C. maltaromaticum found on commercially available foods. Sakala et al. (2002) determined that two beef samples contained C. maltaromaticum. It was detected at 0, 1, 3, 5 and 6 weeks of storage (vacuum-packaged and stored at 2° C.) at mean numbers of 2×10³, 2×10⁴, 2.5×10⁶, 1×10⁷ and 2.5×10⁷ cfu/g Of meat, respectively. Montet (2000) found that at the end of the fermentation period of sausages, tactic acid bacteria were generally the dominant bacterial flora, with C. maltaromaticum naturally present during the fermentation period at levels of

approximately 5×10⁷ cfu/g of sausage, but disappeared afterwards. Sterile cold smoked salmon inoculated with C. maltaromaticum at 10⁴-10⁵ cfu/g of salmon was found to have final counts ranging between 5×10⁷ to 10⁹ cfu/g, after two to three weeks of storage at 6° C. (Stohr at al., 2001). Nadon et al (2001) showed that LAB (which included carnobacteria) increased from an initial 100 cfu/cm² to an average level of 1×10⁶ cfu/cm² for the first six weeks of storage in vacuum-packaged or carbon dioxide-controlled atmosphere-packaged (CO₂-CAP) treated pork and maintained that level of LAB for the remainder of the thirteen-week study. In the CO₂ -CAP pork samples, there was no significant increase in LAB until the 11th week of storage, with a maximum level of LAB at 3.2×10⁵ cfu/cm². Unpublished work by Nadon et al. (2001) demonstrated that carnobacteria dominate the LAB microflora during storage at −1.5° C. in the absence of oxygen.

### Example 14

Strains of C. maltaromaticum produce several different carnobacteriocins (Quadri et al., 1994), which have been identified as heat-resistant peptides, stable over a wide pH range and capable of acting as bactericides (Jack et al., 1996). A bacteriocin from C. maltaromaticum L103 was recently tested in a study to determine the ability of this bacteriocin to control the growth of Listeria monocytogenes in vacuum-packaged meat (Schobitz et al., 1999). Steaks from beef semitendinosus muscle were inoculated with the partially purified bacteriocin at a concentration of 100 AU/ml (AU/ml=Arbitrary units of activity). L. monocytogenes was added to the meat as an indicator strain at a final concentration of 1×10³ cfu/cm². After assuring good contact with the meat, the steaks were vacuum-packaged and stored at 4° C. for 21 days. Non-inoculated controls and meat containing only the indicator strain were included for each sampling date. Duplicate steaks were sampled at time 0 and every seven days for growth of L. monocytogenes and LAB growth. After seven days of storage at 4° C., a significant decrease in the L. monocytogenes counts were observed, from an initial count of 2×10³ cfu/cm²to 4 cfu/cm² with complete inhibition of the pathogen (<1 cfu/cm²) on day 14 of storage. The LAB multiplied on the vacuum-packaged meats, reaching counts of 1×10⁷ cfu/cm² after 14 days, with a starting level of 1.6×10² cfu/cm². Color and odor of the meat remained acceptable during the 14 days of storage. The results of this study indicate that the bacteriocin from C. maltaromaticum was able to inhibit L. monocytogenes on vacuum-packaged meat, while maintaining edible characteristics of the meat for up to 14 days (Schobitz et al., 1999). C. maltaromaticum LV61 produces a bacteriocin that was active against C. maltaromaticum 2762 and L. monocytogenes (strains R2, Lud 1033, Br1246,

Lud 905 and T), but was inactivated by pronase E, proteinase K and trypsin (Pilet et al., 1995). Other research has indicated that the purified bacteriocin from C. maltaromaticum LV61 inhibits several strains of Carnobacterium and Enterococcus, but does not inhibit several strains of Listeria (Holck et al., 1994). It was therefore concluded that C. maltaromaticum LV61 produces, in addition to piscicolin 61, another factor involved in the anti-listerial activity.

### Example 15

Carnobacterium spp. are psychrotrophic, grow at elevated pH values of 8 to 9 and ferment inulin. In culture conditions in the presence of inulin C. maltaromaticum forms yellowish to pinkish colonies with a metallic bronze sheen, a yellow color change of the medium and a clearance of precipitate. Various C. maltaromaticum strains have been shown to produce bacteriocins, proteinaceous compounds with the ability to inhibit the growth of other Carnobacterium, Lactobacillus and Listeria species.

It is proposed that C. maltaromaticum will be inoculated into various ready-to-eat and fresh comminuted, processed meat products at a range of 1×10³ to 1×10⁴ cfu/g for enhanced preservation and decreased pathogenic bacterial growth. Based on these inoculation ranges, as well as the theoretical assumption that the bacteria will grow over an extended period of time in storage, the mean per capita consumption estimate of C. maltaromaticum as an addition to the selected RTE foods would be 4.3×10⁹ cfu/day or 7.2×10⁷ cfu/kg/day for a kg person.

The suppression of the pathogen, L. monocytogenes, by C. maltaromaticum occurs when assessed in salmon, chicken, pork, beef and other commercial meat products. Co-culturing of C. maltaromaticum with L. monocytogenes results in log reductions in L. monocytogenes growth. Compared with L. monocytogenes growth at low temperatures, the suppressive effect of C. maltaromaticum on L. monocytogenes growth is enhanced at low temperatures. L. monocytogenes suppression may be mediated through production of tactic acid, competition for nutrients, as well as the production of bacteriocins. Bacteriocin production is correlated with increased suppression of L. monocytogenes growth. The activity of bacteriocins produced by C. maltaromaticum is rapidly degraded when subjected to simulated gastric acid or proteolytic enzymes, an indication of a non-toxic and non-allergenic protein.

C. maltaromaticum increases the storage time of RTE and vacuum-packaged meat products, while decreasing the growth of pathogenic bacteria. C. maltaromaticum growth has been found to be self-limiting, with levels of C. maltaromaticum on RTE meat products and vacuum-packaged, cold-smoked salmon stabilizing at approximately 1×10⁹ cfu/g. Addition of C. maltaromaticum to the proposed RTE and fresh comminuted, processed meat products at a level between 1×10³ and 1×10⁴ cfu/g, would not significantly increase the overall human consumption of LAB from these food products (theoretical natural consumption determined at 4.3×10⁹ cfu/day). C. maltaromaticum has been shown to be self-limiting in its growth; the growth of C. maltaromaticum will plateau between approximately 1×10⁶ and 1×10⁹ cfu/g of meat. This has been speculated to be due to the release of specific bacteriocins that limit a higher bacterial density.

### Example 16

### Isolation and Screening Procedures for Lactic Acid Bacteria (Lab) from Meat Products

Samples of refrigerated or frozen, raw and ready-to-eat processed meats were:
A) Samples purchased in the retail marketplace; taken to the laboratory for microbiological analysis
B) Frozen samples from a pilot-plant manufacture of raw pork sausages, thawed and subjected to microbiological analysis
C) Samples of ready-to-eat processed meats purchased in the retail marketplace and stored at 4° C. in the laboratory until their “best before date” and subjected to microbiological analysis

Triplicate 10 g samples were aseptically excised from each package, diluted in 90 mL of sterile 0.1% peptone water and homogenized in a Stomacher Lab-Blender 400 (Seward, England) for 2 minutes. Serial dilutions of the homogenate were prepared in 0.1% peptone water and plated onto prepoured plates of APT (All Purpose Tween; Difco) agar (1.5%). Plates were incubated anaerobically (A, B) and aerobically (C) for 48 hours at 25° C. (A, B) or 15° C. (C). Randomly selected, single colonies were picked with a sterile toothpick from the APT plates and streaked onto the required number of sets (one set for each indicator strain used for screening) of prepoured APT plates. The plates were incubated anaerobically (A) and aerobically (B, C) for 24 hours at 25° C. Each set of plates was overlayered with a lawn of L. monocytogenes indicator strain or a universal indicator strain Carnobacterium divergens LV13, seeded at 1% in soft APT agar (0.75%). The overlayered plates were incubated at 37° C. for 24 hours. Zones of inhibition, observed as areas of clearing in the overlayer were recorded as organisms producing antibacterial substances. The organisms exhibiting this activity were screened for susceptibility to pronase E (Sigma) and for heat sensitivity. Those that were sensitive to pronase and stable at 60° C. for 30 minutes were selected for further characterization.

### Example 17

Many bacteria produce antibacterial peptides or proteins (e.g., bacteriocins) that are generally active against other bacteria, typically closely related. An exemplary list of bacteria and their bacteriocins are shown in Table 6.

TABLE 6

| | |
|---|---|
| Strain | Bacteriocin |

Our lab collection of LAB

| | | |
|---|---|---|
| 1. | Carnobacterium maltaromaticum CB1 | carnobacteriocin BM1, piscicolin |
| | | 126 + unknown |
| 2. | C. maltaromaticum CB2 | carnobacteriocin BM1, piscicolin |
| | | 126 + unknown |
| 3. | C. maltaromaticum CB3 | carnobacteriocin BM1, piscicolin 126 |
| 4. | C. maltaromaticum UAL26 | piscicolin 126 |
| 5. | C. maltaromaticum LV17 | carnobacteriocin A, BM1 and B2 |
| 6. | C. maltaromaticum UAL26/8A | piscicolin 126, carnobacteriocin A |
| 7. | Carnobacterium divergens LV13 | divergicin A |
| 8. | Leuconostoc gelidum UAL 187 | leucocin A |
| 9. | Lactobacillus sakei UAL 185 | unknown |
| 10. | Leuconostoc spp. UAL280 | unknown |

Non-LAB inhibiting Listeria spp.

| | | |
|---|---|---|
| 11. | Brochothrix campestris ATCC43754 | brochocin C |
| 12. | Staphylococcus aureus A53 | aureocin A53 |
| 13. | Brevibacterium linens ATCC9175 | unknown |
| 14. | B. linens OC2 | linenscin OC2 |
| 15. | Bifidobacterium bifidum NCFB1454 | bifidocin B |

Meat applied LAB inhibiting Listeria

| | | |
|---|---|---|
| 16. | C. maltaromaticum LV61 | carnobacteriocin A |
| 17. | C. maltaromaticum V1 | carnobacteriocin BM1, piscicolin 126 |
| 18. | C. maltaromaticum CP5 | carnobacteriocin BM1 and B2 |
| 19. | C. maltaromaticum JG126 | piscicolin 126 |
| 20. | Carnobacterium spp. 377 | carnocin H |
| 21. | C. maltaromaticum UI49 | carnocin UI49 |
| 22. | C. divergens 750 | divergicin 750 |
| 23. | Pediococcus acidilactici PAC1.0 | pediocin PA-1 |
| 24. | P. acidilactici E | pediocin PA-1 |
| 25. | P. acidilactici F | pediocin PA-1 |
| 26. | P. acidilactici H | pediocin PA-1 |
| 27. | P. acidilactici JD1-23 | pediocin PA-1 |
| 28. | P. acidilactici M | pediocin PA-1 |
| 29. | P. pentosaceous Z102 | pediocin PA-1 |
| 30. | Lactobacillus plantarum WHE92 | pediocin PA-1 |
| 31. | L plantarum ALC01 | pediocin PA-1 |
| 32. | Lactobacillus sakei Lb706 | sakacin A |
| 33. | Lb. sakei CTC494 | sakacin A |
| 34. | Lactobacillus curvatusLTH1174 | sakacin A |
| 35. | Lb. sakei LTH673 | sakacin P |
| 36. | Lb. sakei 674 | sakacin P |
| 37. | Lactobacillus bavaricus MI401 | sakacin P |
| 38. | Lb. sakei MN | bavaricin MN |
| 39. | Enterococcus faecium CTC492 | enterocin A and B |
| 40. | E. faecium T136 | enterocin A and B |
| 41. | E. faecium WHE81 | enterocin A and B |
| 42. | E. faecium BFE900 | enterocin A and B |
| 43. | E. faecium L50 | enterocin L50A and L50B, P, Q |
| 44. | E. faecium DPC1146 | enterocin A |
| 45. | E. faecium EK13 | enterocin A and P |
| 46. | E. faecium P13 | enterocin P |
| 47. | E. faecium AA13 | enterocin P |
| 48. | E. faecium G16 | enterocin P |
| 49. | E. faecium JCM5804T | enterocin A, B, P |
| 50. | Enterococcus casseliflavusIM416K1 | enterocin 416K1 |
| 51. | Leuconostoc carnosum 4010 | leucocin A and C |
| 52. | Lb. plantarum UG1 | plantaricin UG1 |
| 53. | E. faecium CRL35 | enterocin CRL35 |
| 54. | Lactobacillus casei CRL705 | lactocin CRL705 |
| 55. | Lb. sakei CTC494 | sakacin K |
| 56. | L. carnosum | leucocin F10 |
| 57. | L. carnosum | leucocin B-Ta11a |
| 58. | Lactobacillus brevis VB286 | brevicin 286 |
| 59. | Lb. plantarum CTC305 | unknown |
| 60. | Lb. plantarum CTC306 | unknown |
| 61. | Lb. sakei CTC372 | unknown |

LAB inhibiting Listeria

| | | |
|---|---|---|
| 62. | C. maltaromaticum CS526 | unknown |
| 63. | Streptococcus thermophilus Sfi13 | thermophilin 13 |
| 64. | E. faecalis EJ97 | enterocin EJ97 |
| 65. | E. faecalis BFE1071 | enterocin 1071 |
| 66. | E. faecalis FAIR-E309 | enterocin 1071 |
| 67. | E. faecalis YI717 | bacteriocin 31 |
| 68. | E. faecalis LMG2333 | enterolysin A |
| 69. | E. faecalis DPC5280 | enterolysin A |
| 70. | E. faecalis S-48 | enterocin AS-48 |
| 71. | E. faecalis INIA4 | enterocin AS-48 |
| 72. | Lb. plantarum ALC01 | pediocin PA-1 |
| 73. | Lb. sake 2512 | sakacin G |
| 74. | Lb. plantarum 423 | plantaricin 423 |
| 75. | Enterococcus mundtii ATO6 | mundticin |
| 76. | E. mundtii NFRI7393 | mundticin KS |
| 77. | Lactobacillus buchneri | buchnericin-LB |
| 78. | L. lactis MMFII | lactococcin MMFII |
| 79. | L. lactis UL720 | diacetin B |
| 80. | Enterococcus gallinarum 012 | enterocin 012 |
| 81. | Lb. plantarum | plantaricin NA |
| 82. | Leuconostoc mesenteroides FR52 | mesenterocin 52A |
| 83. | L. mesenteroides Y105 | mesentericinY105 |

Lantibiotics inhibiting Listeria

| | | |
|---|---|---|
| 84. | L. lactis | nisin |
| 85. | L. lactis | nisin Z |
| 86. | L. lactis 61-14 | nisin Q |
| 87. | L. lactis DPC3147 | lacticin3147 |

Other bacteriocin producing bacteria

| | | |
|---|---|---|
| 88. | L. lactis | lactococcin A, B, M |
| 89. | L. lactis LMG280 | lactococcin G |
| 90. | L. lactis IPLA972 | lactococcin 972 |
| 91. | L. lactis DPC5552 | lacticin 481 |
| 92. | L. lactis BGMN1-5 | LsbA, LsbB |
| 93. | Lactobacillus johnsonii VPI11088 | lactacin F |
| 94. | Lactobacillus acidophilusM46 | acidocin B |
| 95. | Lb. acidophilus N2 | lactacin B |
| 96. | Lactobacillus gasseri LA39 | gassericin A |
| 97. | Lactobacillus salivarius UCC118 | ABP-118 |
| 98. | L. plantarum C11 | plantaricn E/F, J/K |
| 99. | L. plantarum NC8 | plantaricin NC8 |
| 100. | Propionibacterium jensenii DF1 | propionicin SM1 |
| 101. | Escherichia coli | colicin V |
| 102. | E. coli | colicin Y101 |
| 103. | E. coli | microcin H47 |
| 104. | Staphylococcus epidermis | epidermin |
| 105. | Bacillus subtilis 168 | subtilosin A |
| 106. | Lb. gasseri | gassericin K7B |
| 107. | Klebsiella pneumoniae | microcin E492 |
| 108. | Clostridium tyrobutyricumADRIAT932 | closticin574 |
| 109. | Clostridium beijerinckii ATCC25752 | circularin A |
| 110. | Lactobacillus amylovorus DCE471 | amylovorin L471 |
| 111. | Lb. plantarum SA6 | plantaricin SA6 |
| 112. | Lb. sakei L45 | lactocinS |

The following bacteriocins are called microcins produced by
gram-negative bacteria:

| | | |
|---|---|---|
| 1. | Klebsiella pneumoniae RYC492 | microcin E492 (same as 107) |
| 2. | E. coli | microcin V (same as 101, |
| | | colicin is “old” name) |
| 3. | E. coli | microcin Y101 (same as 102) |
| 4. | E. coli | microcin H47 |
| 5. | E. coli | microcin L |
| 6. | E. coli | microcin 24 |

### Example 18

This Example illustrates controlled spoilage by selected bacteria of regular BBQ frankfurters.

Freshly manufactured Regular BBQ frankfurters were inoculated by dipping in cultures of either Carnobacterium piscicola NCIMB 702852 or Leuconostoc gelidum UAL187. For the preparation of inocula, bacteria from frozen culture were subcultured twice in APT broth (Difco; Becton Dickinson) and incubated for 24 hours at 25°. The cultures of Carnobacterium piscicola NCIMB 702852 or Leuconostoc gelidum UAL187 were standardized with sterile distilled water such that the dipped frankfurters were inoculated with preferably ≦10³ per cm². In the control samples, sterile water was substituted for the cultures. The inoculated frankfurters were dried on a sterile rack and vacuum packaged (2 per pack). The frankfurters were stored at 4° C. Packages of frankfurters were removed from storage and the total bacterial population, specific bacterial population and flavor were determined.

Samples were prepared for microbial analysis by excising a piece of frankfurter with flame sterilized scalpels. A ten-gram sample of frankfurter was placed in a sterile Stomacher bag, homogenized for 2 minutes with 90 ml of sterile 0.1% peptone water using a Colworth Stomacher 400or similar. Bacterial numbers were enumerated by standard dilution and plating techniques. Total aerobic plate count was determined on Plate Count Agar (PCA, Difco) incubated aerobically at 25° C. for 48 hours. Lactic acid bacteria counts were determined on Bacto APT agar (Difco) incubated anaerobically (BBL Anaerobic System with 5 to 10% CO₂) for 48 hours. Carnobacterium piscicola numbers were determined by difference on Lactobacilli MRS agar (Difco) for 48 hours. Acetate inhibits or retards the growth of Carnobacterium. Numbers of Leuconostoc gelidum were determined by difference on APT with sucrose added.

Bacterial numbers were enumerated by standard dilution and plating techniques. Total aerobic plate count was determined on Plate Count agar (PCA, Difco) incubated aerobically at 25° C. for 48 hours. Lactic acid bacteria counts were determined on Bacto APT agar (Difco) incubated anaerobically (BBL Anaerobic System with 5 to 10% CO₂) for 48 hours. Carnobacterium piscicola numbers were determined by difference on Lactobacilli MRS agar (Difco) for 48 hours. Acetate inhibits or retards the growth of Canobacterium. Bacterial numbers are reported as Colony Forming Units per gram (“CFU/g”).

Samples for sensory analysis were evaluated unheated at room temperature.

A trained panel was used to evaluate the sensory quality of the frankfurters throughout the storage period. The flavor of the inoculated frankfurters was compared with the control on a five point scale, 1=acceptable, 3=marginal, 5=unacceptable.

When the frankfurters were inoculated with Carnobacterium piscicola or Leuconostoc gelidum cells 10-fold higher than the natural bacterial flora then, predicted controlled spoilage by the inoculated bacterium ensued. However, only frankfurters inoculated with Carnobacterium piscicola showed predicted spoilage equivalent to the control without compromising the products flavor.

### Example 19

This Example illustrates antimicrobial activity of two strains of Carnobacterium piscicola.

Three compatible strains of L. monocytogenes (List4, HPB65 and HPB642) were grown separately, centrifuged and washed three times with sterile 0.85% saline and resuspended in sterile 0.85% saline for use as the “Listeria” inoculum “cocktail”. L. monocytogenes CDC 7662 was grown separately and inoculated as a single bacterial culture. The lactic acid bacteria (Carnobacterium piscicola UAL26 or UAL26 /8A) were grown separately, centrifuged and washed three times with sterile 0.85% saline and resuspended separately in sterile 0.85% saline for use as the “lactic” inocula.

Freshly prepared, regular frankfurters were obtained from a meat processor in Edmonton and they were inoculated by immersion in the inoculum containing either the washed Listeria cocktail or the single L. monocytogenes culture, and the lactic acid bacterium. The inoculated frankfurters were dried on a sterile rack and vacuum packaged. The following treatments were prepared:

Un-inoculated control. Dipped in sterile 0.85% saline.

Inoculated control. Dipped in 0.85% saline containing the L. monocytogenes CDC 7662 or the L. monocytogenes cocktail to give ˜1000 CPU of Listeria per cm².

L. monocytogenes CDC 7662 or L. monocytogenes cocktail+Carnobacterium piscicola UAL26 to give 1000 CFU of Listeria and 10,000 CFU of Carnobacterium piscicola UAL26 per cm².

L. monocytogenes CDC 7662 or L. monocytogenes cocktail+Carnobacterium piscicola UAL26/8A to give 1000 CU of Listeria and 10,000 CFU of Carnobacterium piscicola UAL26/8A per cm².

Two frankfurters from each treatment were aseptically transferred to a high barrier film plastic bag and vacuum packaged. The frankfurters were stored at 4° C. and sampled once per week (days 0, 7, 14, 21, 28, 35, 42, 49, 56, 63, 70).

Samples were prepared for microbial analysis by excising a piece of frankfurter with flame-sterilized scalpels to give a sample with 10 cm² surface area. The sample of the frankfurter was placed in a sterile Stomacher bag, homogenized for 2 minutes with 90 ml of sterile 0.1% peptone water using a Colworth Stomacher 400 or similar.

Bacterial numbers were enumerated by standard dilution and plating techniques. Total aerobic plate count was determined on Plate Count agar (PCA, Difco) incubated aerobically at 25° C. for 48 hours. Lactic acid bacterial numbers were determined on Bacto APT agar (Difco) incubated anaerobically (BBL Anaerobic System with 5 to 10% CO₂) at 25° C. for 48 hours. Listeria monocytogenes counts were determined on PALCAM Agar Base (Oxoid, Unipath Ltd., England) supplemented with selective supplement (SR150E, Oxoid). Plates were incubated at 37° C. for 24 h and enumerated.

Bacterial numbers are reported as logarithms (“log10”) Colony Forming Units per gram (“LOG CFU/g”). When the frankfurters were inoculated with the Carnobacterium UAL26 or UAL26/8A at a level that was 10-fold higher than the Listeria cocktail or L. monocytogenes COD 7662 the controlled predicted spoilage population inhibited the growth of L. monocytogenes.

### Example 20

This example illustrates the impact of the growth of Carnobacterium piscicola and Leuconostoc gelidum on the sensory characteristics of vacuum packaged frankfurters.

The following laboratory-scale study was designed to investigate the sensory characteristics of Carnobacterium piscicola and Leuconostoc gelidum on vacuum packaged frankfurters inoculated under controlled conditions.

Two strains of Carnobacterium piscicola NCIMB 702852 and UAL26 and Leuconostoc gelidum UAL187 were investigated.

For the preparation of inocula, bacteria from frozen culture were subcultured twice in APT broth (Difco) over 24 hours at room temperature. Cultures were centrifuged (10,000 rpm for 10 min, at 7° C.) and pelleted cells were resuspended with 0.85% sterile saline and washed three times by centrifugation. The final cell pellet was resuspended in 10 mL of sterile 0.85% saline to a final concentration of 1×10⁹ CFU per mL. Prior to dipping 10 mL aliquot of washed bacterial cells was added to 4 L of sterile 0.85% saline to provide an inoculum solution of 2.5×10⁶ CFU per mL. Groups of 5 frankfurters were dipped into the inoculum suspension for 1 minute, drain dried, and vacuum packaged (high barrier, low O₂ permeability bags). For control samples, frankfurters were dipped in 0.85% sterile saline without bacterial inoculum. Reference samples were frankfurters that had been dipped in a 0.85% saline solution and stored as described for treated samples.

Treated and control samples were placed into refrigerated 4° C. storage (monitored with a Delphi temperature recorder) for up to 12 weeks. Sampling of frankfurters for sensory evaluation was performed on day 0 and after 2, 4, 6, 7, 8 10 and 12 weeks of storage.

Prior to sensory evaluation by a trained panel, frankfurters (4-5) were heated by placing in a saucepan containing 2 L of boiling tap water, which was immediately removed from the heat element and allowed to stand for 5 min (internal temperature approx. 83° C.), frankfurters were cut into 1.27 cm (0.5 inch) pieces and placed in coded foil-covered jars, and just prior to evaluation, heated for 15 min in a 200° F. (94° C.) oven (internal temperature approx. 66° C.).

Sensory evaluation was conducted by a group of 9 panelists trained over a three-month period, and was performed in sensory booths under dim red lighting using data collection software. Samples were evaluated for overall aroma intensity, meat flavor intensity, seasoned flavor, smoke intensity, sourness/acidity, off flavor and overall acceptability using a 15 cm unstructured line scale with 0=none (or very bland) and 15=extreme (or very strong). Between samples, palates were cleansed with crackers and a 1:1 dilution of 7-up.

All collected data were analyzed using the GLM of SAS version 6.12 (SAS Institute, 1996) and the Student Newman Keul's multiple range test was used to test for significant differences among treatments and storage times.

After 12 weeks of cold storage, frankfurters inoculated with Carnobacterium piscicola NCIMB 702852 and UAL26 were similar to control and reference samples for all characteristics. Samples inoculated with strain NCIMB 702852 had slightly higher off-flavor scores (4.5) at week 12 than samples inoculated with UAL26 (2.6), frankfurters inoculated with Leuconostoc gelidum UAL187 were unacceptable or spoiled by week 7 following inoculation and the samples were significantly different from the control samples in aroma, meaty, seasoning, smoky, sour and off-flavors.

Based on sensory evaluations using a trained nine-member panel over the 12-week storage period, there were no significant adverse effects on aroma, off-flavors, sour intensity, or overall acceptability resulting from inoculation of frankfurters with Carnobacterium piscicola.

### REFERENCES

Aguirre, M. and Collins, M. D. (1993) Lactic acid bacteria and human clinical infection. Journal of Applied Bacteriology 75:95-107.
Ahn, C. and Stiles, M. E. (1990a) Antibacterial activity of lactic acid bacteria isolated from vacuum-packaged meats. Journal of Applied Bacteriology 69:302-310.
Ahn, C. and Stiles, M. E. (1990b) Plasmid-associated bacteriocin production by a strain of Carnobacterium piscicola from meat. Applied and Environmental Microbiology 56:2503-2510.
Ajdic, D.; McShan, W. M.; McLaughlin, R. E.; Savic, C.; Chang, J.; Carson, M. B.; Primeaux, C.; Tian, R.; Kenton, S.; Jia, H.; Lin, S.; Qian, Y.; Li, S.; Zhu, H.; Najar, F.; Lai, H.; White, J.; Roe, B. A. and Ferretti, J. J. (2002) Genome sequence of Streptococcus mutans UA159, a cariogenic dental pathogen. Proceedings of the National Academy of Sciences of the United States of America 99:14434-14439.
American Type Culture Collection (ATCC): Collections and Repository (2004a). Biosafety Levels URL: http://www.atcc.orgTechnicallinfo/BiosafetyLevels.cfm
American Type Culture Collection (ATCC): Collections and Repository (2004b). Bacteria. ATCC Numbers: 43225 & 35586 URL: http://www.atcc.org/SearchCatalogs/AtccNumber.cfm?formtext=empty
Amezquita, A. and Brashears, M. M. (2002) Competitive inhibition of Listeria monocytogenes in ready-to-eat meat products by lactic acid bacteria. Journal of Food Protection 65:316-325.
Antibiogram Committee of the French Society for Microbiology (1998) 1998 Statement. Extrait de Pathologie Biologie 46:1-16 (translated from French).
Barakat, R. K.; Griffiths, M. W. and Harris, L. J. (2000) Isolation and characterization of Carnobacterium, Lactococcus, and Enterococcus spp. from cooked, modified atmosphere packaged, refrigerated, poultry meat. International Journal of Food Microbiology 62:83-94.
Baya, A. M.; Toranzo, A. E.; Lupiani, B.; Li, T.; Roberson, B. S. and Hetrick, F. M. (1991) Biochemical and serological characterization of Carnobacterium spp. isolated from farmed and natural populations of striped bass and catfish. Applied and Environmental Microbiology 57:3114-3120.
Biocca, E. and Seppilli, A. (1946) Human infections caused by Lactobacilli. Lactobacilli 112-115.
Borriello, S. P.; Hammes, W. P.; Holzapfel, W.; Marteau, P.; Schrezenmeir, J.; Vaara, M. and Valtonen, V. (2003) Safety of probiotics that contain lactobacilli or bifidobacteria. Clinical Infectious Diseases 36:775-80.
Buchanan, R. L. and Klawitter, L. A. (1992a) Characterization of a lactic acid bacterium, Carnobacterium piscicola LK5, with activity against Listeria monocytogenes at refrigeration temperatures. Journal of Food Safety 12:199-217.
Buchanan, R. L. and Klawitter, L. A. (1992b) Effectiveness of Carnobacterium piscicola LK5 for controlling the growth of Listeria monocytogenes Scott A in refrigerated foods. Journal of Food Safety 12:219-236.
Campos, C. A.; Mazzotta, A. S. and Montville, T. J. (1997) Inhibition of Listeria monocytogenes by Carnobacterium piscicola in vacuum-packaged cooked chicken at refrigeration temperatures. Journal of Food Safety 17:151-160.
Charteris, W. P., Kelly, P. M., Morelli, L. and Collins, J. K. (1998) Antibiotic susceptibility of potentially probiotic Lactobacillus species. Journal of Food Protection 61:1636-43.
Carr, F. J.; Chill, D. and Maida, N. (2002) The lactic acid bacteria: A literature survey. Critical Reviews in Microbiology 28:281-370.
Chmelar, D.; Matusek, A. Korger, J.; Durnova, E.; Steffen M. and Chmelarova, E. (2002) Isolation of Carnobacterium piscicola from human pus-Case report. Folis Microbiol (Praha) 47:455-457.
Collins, M. D.; Farrow, J. A. E.; Phillips, B. A.; Ferusu, S. and Jones, D. (1987) Classification of Lactobacillus divergens, Lactobacillus piscicola, and some catalase-negative, asporogenous, rod shaped bacteria from poultry in a new genus, Carnobacterium. International Journal of Systematic Bacteriology October: 310-316.
Collins. M. D.; Rodrigues, U.; Ash, C.; Aguirre, M.; Farrow, J. A. E.; Martinez-Murcia, A.; Phillips, B. A.; Williams, A. M. and Wallbanks, S. (1991) Phylogenetic analysis of the genus Lactobacillus and related lactic acid bacteria as determined by reverse transcriptase sequencing of 16S rRNA. FEMS Microbiology Letters 77:5-12.
Coventry, M. J.; Gordon, J. B.; Wilcock, A.; Harmark, K.; Davidson, B. E.; Hickey, M. W.; Hillier, A. J. and Wan, J. (1997) Detection of bacteriocins of lactic acid bacteria isolated from foods and comparison with pediocin and nisin. Journal of Applied Microbiology 83:248-258.
Danielsen, M. and Wind, A. (2003) Susceptibility of Lactobacillus spp. to antimicrobial agents. International Journal of Food Microbiology 82:1-11.
De Bruyn, I. N.; Holzapfel, W. H.; Visser, L. and Louw, A. I. (1988) Glucose metabolism by Lactobacillus divergens. Journal of Genetic Microbiology 134 (Pt 8):2103-2109.
Den Brinker, C.; Kerr, M. and Rayner, C. (1995, site visited on Dec. 5, 2003) Investigation of biogenic amines in fish and fish products. Victorian Government Department of Human Services. <http://www.foodsafety.vic.gov.au/downloads/histamines_biogenicamines1995.pdf>.
Doganay, M. (2003) Listeriosis: clinical presentation. FEMS immunology and Medical Microbiological Societies 35:173-175.
Donald, B. and Gibson, D. M. (1992) Preliminary observations on the flora of fresh vacuum packed salmon steaks. In Quality Assurance in the Fish Industry. (H. H. Huss, Ed.). Elsevier Science Publishers, Amsterdam, The Netherlands, p. 107-114.
Duffes, F. (1999a) Improving the control of Listeria monocytogenes in cold smoked salmon. Trends in Food Science & Technology 10:211-216.
Duffes, F.; Corre, C.; Leroi, F.; Dousset, X. and Boyaval, P. (1999b) Inhibition of Listeria monocytogenes by in situ produced and semipurified bacteriocins of Carnobacterium spp. on vacuum-packed, refrigerated cold-smoked salmon. Journal of Food Protection 62:1394-1403.
Duffes, F.; Leroi, F.; Boyaval, P. and Dousset, X. (1999c) Inhibition of Listeria monocytogenes by Carnobacterium spp. Strains in a simulated cold smoked fish system stored at 4° C. International Journal of Food Microbiology 47:33-42.
Duffes, F.; Leroi, F.; Dousset, X. and Boyaval, P. (2000) Use of a bacteriocin-producing Carnobacterium piscicola strain, isolated from fish, to control Listeria monocytogenes development in vacuum-packed cold-smoked salmon stored at 4° C. Sciences Des Aliments 20:153-158.
Emborg, J.; Laursen, B.; Rathjen, T. and Dalgaard, P. (2002) Microbial spoilage and formation of biogenic amines in fresh and thawed modified atmosphere-packed salmon (Salmo salar) at 2 degrees C. Journal of Applied Microbiology. 92:790-799.
European Commission. (2002) Health & Consumer Protection Directorate-General (site visited on Jun. 30, 2004) Position paper of the Scientific Committee on Animal Nutrition on: Safety assessment and regulatory aspects of micro-organisms in feed and food applications. http://europa.eu.int/comm/food/fs/sc/scan/out85_en.pdf
Euzeby, J. P. (site visited on May 7, 2004) Veterinary Dictionary of Bacteriology. Carnobacterium. http://www.bactero.cict.fr/bacdico/cc/carnobacerium.html
Gasser, G. A. (1994) Safety of lactic acid fermentation and their occurrence in human clinical infections. Bulletin. Institut Pasteur 92:45-67.
Gil, C. O. and Newton, K. G. (1978) The ecology of bacteria spoilage of fresh meat at chill temperatures. Meat Science 2:207-217.
Gonzalez-Rodriguez, M. N.; Sanz, J. J.; Santos, J. A.; Otero, A. and Garcia Lopez, M. L. (2002) Numbers and types of microorganisms in vacuum-packed cold-smoked freshwater fish at the retail level. International Journal of Food Microbiology 77.161-168.
Grind, M.; Siwers, B.; Graffner, C.; Alvan, G.; Gustafsson, L. L.; Helleday, J.; Lindgren, J. E.; Ogenstad, S. and Selander, H. (1986) Pressor response of oral tyramine in healthy men given amiflamine and placebo. Clinical Pharmacology and Therapeutics 40:155-160.
Hara, S.; Yakazo, K.; Nakakawaji, K.; Takeuchi, T.; Kobayasi, T.; Sata, M.; Imai, Z. and Shibuya T. (1962) An investigation of toxicity of nisin with a particular reference to experimental studies of its oral administration and influences by digestive enzymes. Journal Tokyo Medical College 20:176-207.
Health Canada (site visited on Nov. 10, 2003) Carnobacterium as a non-pathogenic organism, http://www.hc-sc.gc.ca/pphb-dgspsp/ols-bsl/pathogen/pdf/pathogensfinal-092001.pdf
Herbin S.; Mathieu, F.; Brule, F.; Branlant, C.; Lefebvre, G. and Lebrihi, A. (1997) Characteristics and genetic determinants of bacteriocin activities produced by Carnobacterium piscicola CPS isolated from cheese. Current Microbiology 35:319-326.
Hitchener, B. J.; Egan, A. F. and Rogers, P. J. (1982) Characteristics of lactic acid bacteria isolated from vacuum-packaged beef. Journal of Applied Bacteriology 52:31-37.
Hiu, S. F.; Holt, R. A.; Sriranganathan, N.; Seidler, R. J. and Fryer, J. L. (1984) Lactobacillus piscicola, a new species from salmonid fish. International Journal of Systematic Bacteriology 34:393-400.
Holck, A. L.; Axelsson, L. and Schillinger, U. (1994) Purification and cloning of piscicolin 61, a bacteriocin from Carnobacterium piscicola LV61. Current Microbiology. 29:63-68.
Huss, D. H.; Jeppesen, V.; Johansen, C. and Gram, L. (1995) Biopreservation of fish products—a review of recent approaches and results. Journal of Aquatic Food Product Technology 4:5-26.
Izquierdo-Puido, M.; Marine-Font, A. and Vidal-Carou, M. (1994) Biogenic amine formation during matting and brewing. Journal of Food Science 59:1104-1107.
Jack, R. W.; Wan, J.; Gordon, J.; Harmark, K.; Davidson, B. E.; Hillier, A. J.; Wettenhall, R. E.; Hickey, M. W. and Coventry, M. J. (1996) Characterization of the chemical and antimicrobial properties of piscicolin 126, a bacteriocin produced by Carnobacterium piscicola JG126. Applied and Environmental Microbiology 62:2897-2903.
Jansen, S. C.; van Dusseldorp, M.; Bottema, K. C. and Dubois, A. E. (2003) Intolerance to dietary biogenic amines: A review. Annals of Allergy Asthma and Immunology 91:233-240; quiz 241-2, 296.
Joosten, H. M. L. J. (1988) The biogenic amine contents of Dutch cheese and their toxicological significance. Netherlands Milk and Dairy Journal 42:25-42.
Kelly, W. J.; Asmundson, R. V. and Huang, C. M. (1996) Isolation and characterization of bacteriocin-producing lactic acid bacteria from ready-to-eat food products. International Journal of Food Microbiology 33:209-218.
Klaenhammer, T. R. (1993) Genetics of bacteriocins produced by lactic acid bacteria. FEMS Microbiology Reviews 12:39-85.
Kunz, A. N., Noel, J. M. and Fairchok, M. P. (2004) Two cases of Lactobacillus bacteremia during probiotic treatment of short gut syndrome. Journal of Pediatric Gastroenterology and Nutrition 38:457-458.
Labadie, J. (1999) Consequences of packaging on bacterial growth. Meat is an ecological niche. Meat Science 52:299-305.
Lai, S.; Goodacre, R. and Manchester, L. N. (2004) Whole-organism fingerprinting of the genus Carnobacterium using Fourier transform infrared spectroscopy (FT-IR). Systematic and Applied Microbiology 27:186-91.
Lai, S, and Manchester, L. N. (2000) Numerical phenetic study of the genus Carnobacterium. Antonie Van Leeutwenhoek 78:73-85.
Leisner, J. J.; Millan, J. C.; Huss, H. H. and Larsen, L. M. (1994) Production of histamine and tyramine by lactic acid bacteria isolated from vacuum-packed sugar-salted fish. Journal of Applied Bacteriology 76:417-423.
Leroi, F. Arbey. N., Joffraud, C. F. and Chevalier, F. (1996) Effect of inoculation with lactic acid bacteria on extending the shelf life of vacuum-packed cold-smoked salmon. International Journal of Food Science and Technology 31:497-504.
Leroi, F.; Joffraud, J. J.; Chevalier, F. and Cardinal, M. (1998) Study of the microbial ecology of cold-smoked salmon during storage at 8 degrees C. International Journal of Food Microbiology 39:111-121.
Lewus, C. B.; Kaiser, A. and Montville, T. J. (1991) Inhibition of food-borne bacterial pathogens by bacteriocins from lactic acid bacteria isolated from meat. Applied and Environmental Microbiology 57:1683-1688.
Mackay, A. D., Taylor, M. B., Kibbler, C. C. and Hamilton-Miller, J. M. (1999) Lactobacillus endocarditis caused by a probiotic organism. Clinical Microbiology and Infection 5:290-292.
Masson, F.; Talon, R. and Montel, M. C. (1996) Histamine and tyramine production by bacteria from mea t products. International Journal of Food Microbiology 32:199-207.
Mastromarino, P.; Brigidi, P.; Macchia, S.; Maggi, L.; Pirovano, F.; Trinchieri, V.; Conte, U. and Matteuzzi, D. (2002) Characterization and selection of vaginal Lactobacillus strains for the preparation of vaginal tablets. Journal of Applied Microbiology 93:884-893.
McMullen, L. M. and Stiles, M. E. (1996) Potential for use of bacteriocin-producing lactic-acid bacteria in the preservation of meats. Journal of Food Protection 64-71.
Miller, A., Morgan, M. E. and Libbey, L. M. (1974) Lactobacillus maltaromicus, a new species producing a malty aroma. International Journal of Systematic Bacteriology 24:346-354.
Milliere, J. B. and Lefebvre, G. (1994a) Carnobacterium piscicola, a common species of French soft cheeses from cow's raw milk. Netherlands Milk and Dairy Journal 48:19-30.
Milliere, J. B.; Michel, M.; Mathieu, F. and Lefebvre, G. (1994b) Presence of Carnobacterium spp in French surface mould-ripened soft-cheese. Journal of Applied Bacteriology 76:264-269.
Montel, M. (site visited on Nov. 26, 2003) Encyclopedia of Food Microbiology. Fermented Foods. Fermented Meat Products Academic Press, 1999.
   http://apresslp.gvpi.net/apfmicro/lpext.dll/fmicro/a0620-ink?f=templates&fn=documentframe. htm&2.0
Mora, D.; Scarpelllni, M.; Franzetti, L.; Colombo, S, and Galli, A. (2003) Reclassification of Lactobacillus maltaromicus (Miller et al. 1974) DSM 20342(T) and DSM 20344 and Carnobacterium piscicola (Collins et al. 1987) DSM 20730(T) and DSM 20722 as Carnobacterium maltaromaticum comb. nov. International Journal of Systematic and Evolutionary Microbiology 53:675-678.
Morbidity and Mortality Weekly Report (site visited on Nov. 28, 2003) Public Health Dispatch Outbreak of Listeriosis—Northeastern United States, 2002. http://www.cdc.gov/mmwr/preview/mmwrhtml/mm5142a3.htm
Nadon, C. A.; Ismond, M. A. H. and Holley, R. (2001) Biogenic amines in vacuum-packaged and carbon dioxide-controlled atmosphere-packaged fresh pork stored at −1.5 degrees C. Journal of Food Protection 64:220-227.
Nilsson, L.; Gram, L. and Huss, H. H. (1999) Growth control of Listeria monocytogenes on cold smoked salmon using a competitive lactic acid bacteria flora, Journal of Food Protection 62:336-342.
Nissen, H.; Holck, A. and Dainty, R. H. (1994) Identification of Carnobacterium spp. and Leuconostoc spp. in meat by genus-specific 16S rRNA probes. Letters in Applied Microbiology 19:165-168.
Nuessle, W. F.; Norman, F. C and Miler, H. E. (1965) Pickled herring and tranylcypromine reaction. Journal. American Medical Association 192:726-727.
Paludan-Muller, C.; Dalgaard, P.; Huss, H. H. and Gram, L. (1998) Evaluation of the role of Carnobacterium piscicola in spoilage of vacuum- and modified-atmosphere-packed cold-smoked salmon stored at 5 degrees C. International Journal of Food Microbiology. 39:155-166.
Pilet, M.-F.; Dousset, X. and Barre, R. (1995) Evidence for two bacteriocins produced by Carnobacterium piscicola and Carnobacterium divergens isolated from fish and active against Listeria monocytogenes. Journal of Food Protection 58:256-262.
Quadri, L. E.; Sailer, M.; Roy, K. L.; Vederas, J. C. and Stiles, M. E. (1994) Chemical and genetic characterization of bacteriocins produced by Carnobacterium piscicola LV17b. Journal of Biological Chemistry 269:12204-12211.
Rautio, M.; Jousimies-Somer, H.; Kauma, H.; Pietarinen, I.; Saxelin, M.; Tynkkynen, S. and Koskela, M. (1999) Liver abscess due to a Lactobacillus rhamnosus strain indistinguishable from L. rhamnosus strain GG. Clinical Infectious Diseases 28:1159-60.
Republic of France (1994) Ministry of Work, Employment and Professional Development. Decree of the 18th of Jul., 1994 determining the list of pathogenic biological agents. Journal Officiel de la Republique Francaise 11078-11081 (translation from French).
Ringo, E.; Bendiksen, H. R.; Wesmajervi, M. S.; Olsen, R. E.; Jansen, P. A. and Mikkelsen, H. (2000) Lactic acid bacteria associated with the digestive tract of Atlantic salmon (Salmo salar L.), Journal of Applied Microbiology 89:317-322.
Rogosa, M.; Mitchell, J. A. and Wiseman, R. F. (1951) A selective medium for the isolation and enumeration of oral and fecal lactobacilli. National Institute of Dental Research, Journal of Bacteriology 62:132-133.
Sakala, R.; Hayashidani, H.; Kato, Y.; Hirata, T.; Makino, Y.; Fukushima, A.; Yamada, T.; Kaneuchi, C. and Ogawa, M. (2002) Change in the composition of the microflora on vacuum packaged beef during chiller storage. International Journal of Food Microbiology. 74:87-99.
Schillinger, U. and Holzapfel, W. (1990) Antibacterial activity of carnobacteria. Food Microbiology 7:305-310.
Schillinger, U.; Stiles, M. E and Holzapfel, W. H. (1993) Bacteriocin production by Carnobacterium piscicola LV 61. International Journal of Food Microbiology. 20: 131-147.
Schillinger, U. and Hoizapfel, W. H. (1995) The genus Carnobacterium. In The Genera of Lactic Acid Bacteria. (B. J. B. Wood and W. H. Holzapfel Eds.). Blackie Academic & Professional, New York. pp. 307-326.
Schobitz, R.; Zaror, T.; Leon, I. and Costa, M. (1999) A bacteriocin from Carnobacterium piscicola for the control of Listeria monocytogenes in vacuum-packaged meat. Food Microbiology 16:249-255.
Shaw, B. G. and Harding, C. D. (1984) A numerical taxonomic study of lactic acid bacteria from vacuum-packed beef, pork, lamb and bacon. Journal of Applied Bacteriology 56:25-40.
Stainer, R. Y., Doudoroff, M. and Adelberg, E. A. (1957) The Microbial World. Prentice-Hall, Inc., Englewood Cliffs, N.J. pp. 198-205.
Stiles, M. E. and Holzapfel, W. H. (1997) Lactic acid bacteria of foods and their current taxonomy. International Journal of Food Microbiology 36:1-29.
Stoffels, G.; Nes, I. F. and Guthmundsdottir, A. (1992) Isolation and properties of a bacteriocin producing Carnobacterium piscicola isolated from fish. Journal of Applied Bacteriology 73:309-316.
Stohr, V.; Joffraud, J. J.; Cardinal, M. and Leroi, F. (2001) Spoilage potential and sensory profile associated with bacteria isolated from cold-smoked salmon. Food Research International. 34:797-806.
Stratton, J. E. and Taylor, S. L. (1991) Scombroid poisoning. In Microbiology of Marine Food Products. (D. R. Ward and C. Hackney, Eds.). Van Nostrand Reinhold, New York, N.Y. p 331-351.
U.S. Food and Drug Administration (site visited on Nov. 10, 2003). Processing Parameters Needed to Control Pathogens in Cold-Smoked Fish. Potential Hazards in Cold-Smoked Fish, Listeria monocytogenes. http://www.cfsan.fda.gov/˜comm/ift2list.html
US Pharmacopoeia (2000) Simulated Gastric Fluid and Simulated Intestinal Fluid, TS. In The US Pharmacopoeia 26, The National Formulary 18. The US Pharmacopoeia Convention, Inc., Rockville, Md. p. 2235.
Uchida, K. and Mogi, K. (1973) Cellular fatty acid spectra of hiochi bacteria, alcohol-tolerant lactobacilli, and their group separation. Journal of General and Applied Microbiology 19:233-249.
VanDenBerg, C. M.; Blob, L. F.; Kemper, E. M. and Azzaro, A. J. (2003) Tyramine pharmacokinetics and reduced bioavailability with food, Journal of Clinical Pharmacology 43:604-609.
Veerkam p, J. H. (1971) Fatty acid composition of Bifidobacterium and Lactobacillus strains. Journal of Bacteriology 108:861-867.
Vescovo, M., Morelli, L. and Bottazzi, V. (1982) Drug resistance plasmids in Lactobacillus acidophilus and Lactobacillus reuteri. Applied and Environmental Microbiology 43:50-56.
Water Quality and Health Council (site visited on Nov. 24, 2003) Contaminated Meat Cause for Concern Among Regulators and Consumers. Water Quality and Health Council. http://www.waterandhealth.org/newsletter/new/winter_{—}2003/meat.html
Yamazaki, K.; Suzuki, M.; Kawai, Y.; Norio, I. and Montville, T, (2003) Inhibition of Listeria monocytogenes in cold-smoked salmon by Carnobacterium piscicola CS526 isolated from frozen surimi. Journal of Food Protection 66: 1420-1425.

Although a few preferred embodiments have been shown and described, it will be appreciated by those skilled in the art that various changes and modifications might be made without departing from the scope of the invention. The terms and expressions in the preceding specification have been used herein as terms of description and not of limitation, and there is no intention in the use of such terms and expressions of excluding equivalents of the features shown and described or portions thereof, it being recognized that the scope of the invention is defined and limited only be the claims that follow.

We claim:

1. A method for treating food comprising preparing a composition comprising at least one gram-positive bacterium or at least one bacteriocin, or combinations thereof, and contacting the food with said composition.

2. The method of claim 1 wherein treating food comprises treating against one or more deleterious microorganisms.

3. The method of claim 1 wherein treating food comprises preserving the food.

4. The method of claim 2 wherein the deleterious microorganism is Listeria.

5. The method of claim 1 wherein the lactic acid bacteria is at least one
Carnobacteria selected from the group consisting of Carnobacterium piscicola strain CB1 (ATCC Accession No. PTA-5313), Carnobacterium piscicola strain CB2 (ATCC Accession No. 5314), and Carnobacterium piscicola strain CB3 (ATCC Accession No. 5315).

6. The method of claim 1 further comprising administering to the food a fermentate comprising at least one bacteriocin.

7. The method of claim 1 further comprising administering the lactic acid bacteria in combination with a fermentate.

8. The method of claim 1 wherein said host is at least one lactic acid bacterium.
